(19) United States
(12) Patent Application Publication
(10) Pub. No.: US 2026/0325970 A1
(43) Pub. Date: Oct. 22, 2026

(54) ELECTRONIC DEVICE, METHOD, AND NON-TRANSITORY COMPUTER READABLE STORAGE MEDIUM TO DISPLAY VISUAL INDICATION INDICATING SELECTION OF VISUAL OBJECT

(71) Applicant: NCSOFT CORPORATION, Seoul (KR)

(72) Inventors: Junhyeon PARK, Seongnam-si (KR); Doun BAE, Seongnam-si (KR); Taeeun KIM, Seongnam-si (KR)

(73) Assignee: NCSOFT CORPORATION, Seoul (KR)

(21) Appl. No.: 19/650,778

(22) Filed: Apr. 17, 2026

(30) Foreign Application Priority Data
Apr. 18, 2025 (KR) 10-2025-0051182

(51) Int. Cl. A63F 13/5372; A63F 13/355; A63F 13/5375; A63F 13/87

(52) U.S. Cl. CPC A63F 13/5372; A63F 13/355; A63F 13/5375; A63F 13/87

(57) ABSTRACT

An electronic device includes memory storing instructions, communication circuitry, and at least one processor. The instructions cause the electronic device to receive, from a first external electronic device, a first video indicating an execution screen of a game application being executed via the first external electronic device, while receiving the first video, transmit, to a second external electronic device, the first video, while transmitting the first video, receive, from the second external electronic device, a first signal indicating a selection regarding a visual object represented by the first video and an input regarding the selection, and transmit, to the first external electronic device, a second signal causing the first external electronic device to display a visual indication indicating the selection as superimposed on the visual object and to display information associated with the input.

### CROSS-REFERENCE TO RELATED APPLICATIONS

This application is based on and claims priority under 35 U.S.C 119 to Korean Patent Application No. 10-2025-0051182 filed on, Apr. 18, 2025, in the Korean Intellectual Property Office, the disclosures of which is incorporated by reference herein their entirety.

### BACKGROUND

### Field

The present disclosure relates to an electronic device, a method, and a non-transitory computer-readable storage medium for displaying a visual indication indicating a selection of a visual object.

### Description of Related Art

An electronic device may be used to use a service such as live streaming or a video call. The electronic device may transmit, to a second external electronic device via communication circuitry, data obtained from a first external electronic device. While streaming the data to the second external electronic device, the electronic device may receive other data from the second external electronic device via the communication circuitry. The data may indicate at least one of an image, text, and an audio signal. The other data may indicate at least one of an image, text, and an audio signal.

The above-described information may be provided as a related art for the purpose of helping understanding of the present disclosure.

No argument or decision is made as to whether any of the above description may be applied as a prior art related to the present disclosure.

### SUMMARY

An electronic device is described. The electronic device may comprise memory comprising one or more storage media storing instructions. The electronic device may comprise communication circuitry. The electronic device may comprise at least one processor comprising processing circuitry. The instructions, when executed by the at least one processor individually or collectively, may cause the electronic device to receive, via the communication circuitry from a first external electronic device, a first video indicating an execution screen of a game application being executed via the first external electronic device. The instructions, when executed by the at least one processor individually or collectively, may cause the electronic device to, while receiving the first video, transmit, via the communication circuitry to a second external electronic device, the first video. The instructions, when executed by the at least one processor individually or collectively, may cause the electronic device to, while transmitting the first video, receive, via the communication circuitry from the second external electronic device, a first signal indicating a selection regarding a visual object represented by the first video and an input regarding the selection. The instructions, when executed by the at least one processor individually or collectively, may cause the electronic device to, based on receiving the first signal, transmit, via the communication circuitry to the first external electronic device, a second signal causing the first external electronic device to display a visual indication indicating the selection as superimposed on the visual object and to display information associated with the input.

A method is provided. The method may be executed in an electronic device with communication circuitry. The method may comprise receiving, via the communication circuitry from a first external electronic device, a first video indicating an execution screen of a game application being executed via the first external electronic device. The method may comprise, while receiving the first video, transmitting, via the communication circuitry to a second external electronic device, the first video. The method may comprise, while transmitting the first video, receiving, via the communication circuitry from the second external electronic device, a first signal indicating a selection regarding a visual object represented by the first video and an input regarding the selection. The method may comprise, based on receiving the first signal, transmitting, via the communication circuitry to the first external electronic device, a second signal causing the first external electronic device to display a visual indication indicating the selection as superimposed on the visual object and to display information associated with the input.

A non-transitory computer readable storage medium is provided. The non-transitory computer readable storage medium may store one or more programs. The one or more programs may comprise instructions to, when executed by an electronic device with communication circuitry, cause the electronic device to receive, via the communication circuitry from a first external electronic device, a first video indicating an execution screen of a game application being executed via the first external electronic device. The one or more programs may comprise instructions to, when executed by the electronic device, cause the electronic device to, while receiving the first video, transmit, via the communication circuitry to a second external electronic device, the first video. The one or more programs may comprise instructions to, when executed by the electronic device, cause the electronic device to, while transmitting the first video, receive, via the communication circuitry from the second external electronic device, a first signal indicating a selection regarding a visual object represented by the first video and an input regarding the selection. The one or more programs may comprise instructions to, when executed by the electronic device, cause the electronic device to, based on receiving the first signal, transmit, via the communication circuitry to the first external electronic device, a second signal causing the first external electronic device to display a visual indication indicating the selection as superimposed on the visual object and to display information associated with the input.

### BRIEF DESCRIPTION OF THE DRAWINGS

FIG. 1 illustrates an example of a first external electronic device transmitting a game screen.

FIG. 2 is a simplified block diagram of an exemplary electronic device.

FIG. 3 is a simplified block diagram of an exemplary first external electronic device.

FIG. 4 is a simplified block diagram of an exemplary second external electronic device.

FIG. 5 is a flowchart representing an operation of an electronic device transmitting a signal causing that a visual indication is displayed.

FIG. 6 illustrates an example of operations executed in an electronic device, a first external electronic device, and a second external electronic device.

FIG. 7 illustrates an exemplary operation of a second external electronic device selecting a visual object.

FIG. 8 illustrates an exemplary operation of a first external electronic device displaying information associated with a visual object.

FIG. 9 illustrates an exemplary operation of a first external electronic device displaying a UI object for managing a comment.

FIG. 10 illustrates an exemplary operation of a first external electronic device displaying a UI object for determining an external electronic device to which a second video is to be transmitted.

FIG. 11 illustrates an example of a server and one or more user terminals interconnected for a game service.

FIGS. 12A, 12B, and 12C illustrate exemplary cases of providing a user experience associated with a game by using a plurality of user terminals.

FIGS. 13A, 13B, 13C, and 13D illustrate exemplary functions supported by a game launcher executed by a user terminal.

### DETAILED DESCRIPTION

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

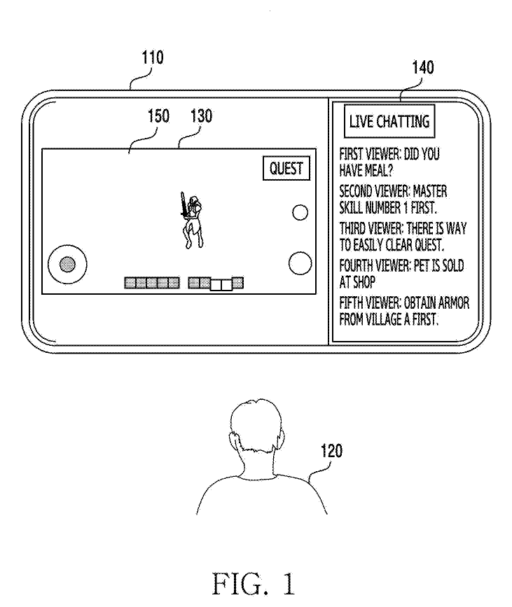

FIG. 1 illustrates an example of a first external electronic device transmitting a game screen.

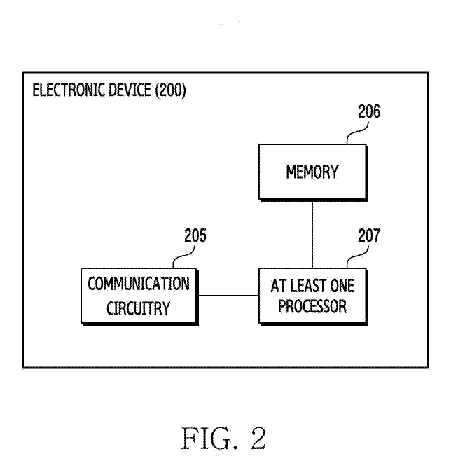

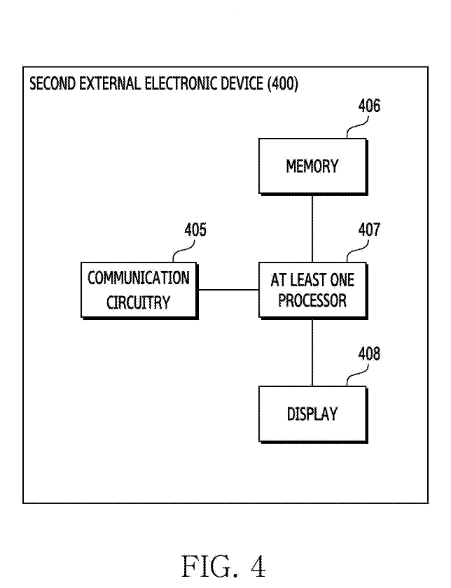

Referring to FIG. 1, a first external electronic device 110 may be used to provide a streaming service. For example, while executing a game application, the first external electronic device 110 may display, via a display 308, a video 150 indicating an execution screen of the game application. For example, while displaying the video 150, the first external electronic device 110 may transmit, via communication circuitry 305, the video 150 to an electronic device (e.g., an electronic device 200 of FIG. 2). For example, while displaying the video 150, the first external electronic device 110 may transmit or stream, via the electronic device (e.g., the electronic device 200 of FIG. 2), the video 150 to a second external electronic device (e.g., a second external electronic device 400 of FIG. 4).

The first external electronic device 110 may display the video 150 on a streaming region 130 included in the display 308. For example, the streaming region 130 may be described as a region in which a transmitted or streamed video or image is displayed. The first external electronic device 110 may display, on a chatting region 140, text received from the second external electronic device (e.g., the second external electronic device 400 of FIG. 4). For example, the chatting region 140 may be described as a region in which text (e.g., a chat) obtained from an external electronic device is displayed, when the first external electronic device 110 provides the streaming service.

When the first external electronic device 110 provides the streaming service, a user 120 of the first external electronic device 110 may enjoy a game application in accordance with text displayed on the chatting region 140. For example, viewers may provide, to the user 120, information associated with a content of the game application based on the video 150. The viewers or the user 120 may want accurate information on the content. The first external electronic device 110 may be required to display, on the video 150, an accurate point in accordance with an instruction of the viewers. For example, when the first external electronic device 110 provides the streaming service, due to a limitation of text or a limitation of a speed of inputting text, it may be difficult to deliver, to the user 120, a position on the video 150. For example, the first external electronic device 110 may be required to indicate a visual object on the video 150 in accordance with an input obtained from the second external electronic device (e.g., the second external electronic device 400 of FIG. 4).

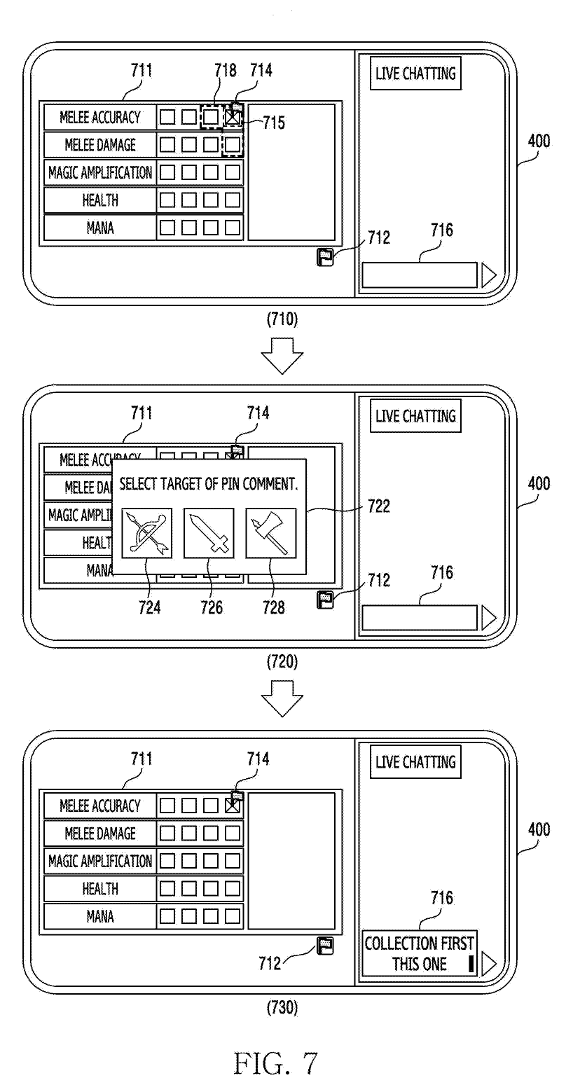

The electronic device (e.g., the electronic device 200 of FIG. 2) may receive, from the second external electronic device (e.g., the second external electronic device 400 of FIG. 4), a signal indicating a selection of a visual object on the video 150, via communication circuitry (e.g., communication circuitry 205 of FIG. 2). For example, based on receiving the signal, the electronic device may transmit, to the first external electronic device 110 or the second external electronic device (e.g., the second external electronic device 400 of FIG. 4), via the communication circuitry (e.g., the communication circuitry 205 of FIG. 2), a signal causing that a visual indication (e.g., a visual indication 714 of FIG. 7) indicating the selection is displayed. For example, based on receiving the signal, the first external electronic device 110 may display, via the display 308, the visual indication indicating the selection. For example, based on recognizing the visual indication, the user 120 may effectively communicate with the viewers.

For example, the electronic device (e.g., the electronic device 200 of FIG. 2) may include hardware components used to perform or execute the operations. The hardware components will be described and exemplified with reference to FIG. 2.

FIG. 2 is a simplified block diagram of an exemplary electronic device.

Referring to FIG. 2, an electronic device 200 may include communication circuitry 205, at least one processor 207, and memory 206.

The at least one processor 207 may include a hardware component for processing data by using instructions stored in the memory 206. The hardware component for processing data may include a central processing unit (CPU) (e.g., including processing circuitry). The hardware component for processing data may include a neural processing unit (NPU) (e.g., including processing circuitry).

The at least one processor 207 may include one or more cores. For example, the at least one processor 207 may have a structure of a multi-core processor such as a dual core, a quad core, or a hexa core.

The memory 206 may include a hardware component for storing data and/or instructions input to the at least one processor 207 and/or output from the at least one processor 207. The memory 206 may include, for example, a volatile memory such as random-access memory (RAM), and/or a non-volatile memory such as read-only memory (ROM). The volatile memory may include, for example, at least one of a dynamic RAM (DRAM), a static RAM (SRAM), a cache RAM, and a pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disc, and an embedded multimedia card (EMMC).

The communication circuitry 205 may include a hardware component for supporting transmission and/or reception of a signal between the electronic device 200 and an external electronic device. The communication circuitry 205 may include, for example, at least one of a modem, an antenna, and an optic/electronic (O/E) converter. The communication circuitry 205 may support transmission and/or reception of a signal based on various types of protocols such as ethernet, a local area network (LAN), a wide area network (WAN), wireless fidelity (WiFi), Bluetooth, Bluetooth low energy (BLE), zigbee, long term evolution (LTE), and 5G new radio (NR).

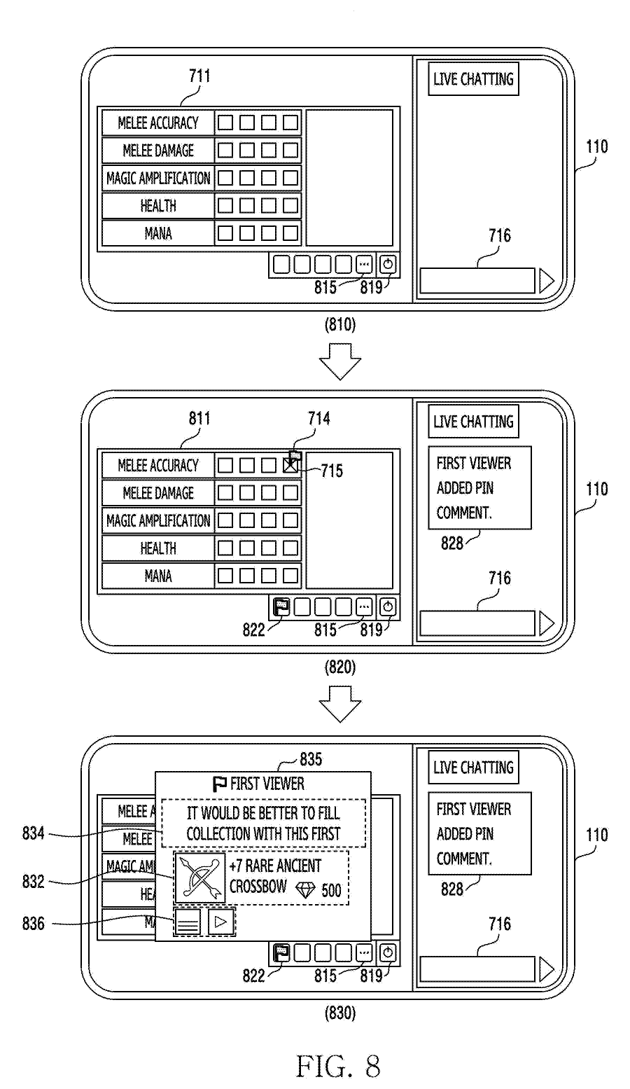

The at least one processor 207 may receive, via the communication circuitry 205, a first video (e.g., the first video 711 of FIG. 7) indicating an execution screen of a game application being executed via a first external electronic device 110, from the first external electronic device. While receiving the first video, the at least one processor 207 may transmit, to a second external electronic device 400 via the communication circuitry 205, the first video. While transmitting the first video, the at least one processor 207 may receive, from the second external electronic device 400 via the communication circuitry 205, a first signal indicating a selection regarding a visual object (e.g., a visual object 715 of FIG. 7) represented by the first video and an input regarding the selection. Based on receiving the first signal, the at least one processor 207 may transmit, to the second external electronic device 400 via the communication circuitry 205, a second signal for providing a second video (e.g., a second video 811 of FIG. 8) of the game application, on which a visual indication (e.g., a visual indication 714 of FIG. 7) indicating the selection is displayed as superimposed on the visual object, and text in accordance with the input.

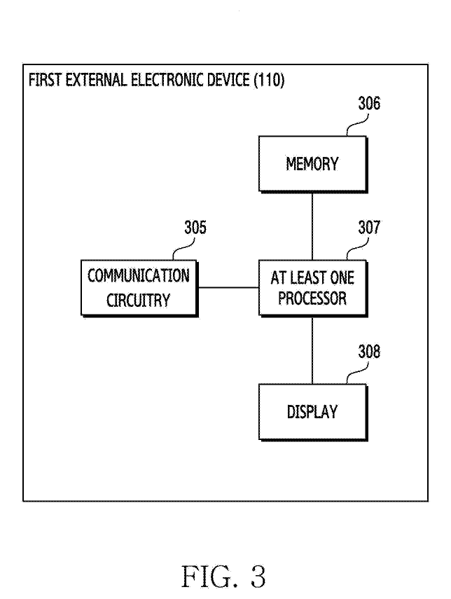

FIG. 3 is a simplified block diagram of an exemplary first external electronic device.

Referring to FIG. 3, a first external electronic device 110 may include a display 308, communication circuitry 305, at least one processor 307, and memory 306.

The at least one processor 307 may include a hardware component for processing data by using instructions stored in the memory 306. The hardware component for processing data may include a central processing unit (CPU) (e.g., including processing circuitry). The hardware component for processing data may include a graphic processing unit (GPU) (e.g., including processing circuitry). The hardware component for processing data may include a display processing unit (DPU) (e.g., including processing circuitry).

The at least one processor 307 may include one or more cores. For example, the at least one processor 307 may have a structure of a multi-core processor such as a dual core, a quad core, or a hexa core.

The memory 306 may include a hardware component for storing data and/or instructions input to the at least one processor 307 and/or output from the at least one processor 307. The memory 306 may include, for example, a volatile memory such as a random-access memory (RAM), and/or a non-volatile memory such as a read-only memory (ROM). The volatile memory may include, for example, at least one of a dynamic RAM (DRAM), a static RAM (SRAM), a cache RAM, and a pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disc, and an embedded multimedia card (EMMC).

The communication circuitry 305 may include a hardware component for supporting transmission and/or reception of a signal between an electronic device (e.g., the first external electronic device 110) and an external electronic device. The communication circuitry 305 may include, for example, at least one of a modem, an antenna, and an optic/electronic (O/E) converter. Communication circuitry 305 may support transmission and/or reception of a signal based on various types of protocols such as ethernet, local area network (LAN), wide area network (WAN), wireless fidelity (WiFi), Bluetooth, Bluetooth low energy (BLE), zigbee, long term evolution (LTE), and 5G new radio (NR).

The display 308 may output visualized information. For example, the display 308 may output, to a user, visualized information in accordance with control of the at least one processor 307. The display 308 may include a hardware component of an electronic device (e.g., the first external electronic device 110) used to display a screen. For example, the display 308 may include light emitting elements and circuits (e.g., transistors) controlling the light emitting elements to emit light. For example, each of the light emitting elements may include an organic light emitting diode (OLED) or a micro LED. However, it is not limited thereto. For example, the display 308 may include a liquid crystal display (LCD).

The at least one processor 307 may sequentially display a first video 711 or a second video 811 via the display 308. For example, while displaying the second video 811, the at least one processor 307 may display, via the display 308, a UI object (e.g., a UI object 835 of FIG. 8) including information associated with a visual object (a visual object 715 of FIG. 7), based on a user input regarding a visual indication (e.g., a visual indication 714 of FIG. 7) included on the second video 811.

FIG. 4 is a simplified block diagram of an exemplary second external electronic device.

Referring to FIG. 4, a second external electronic device 400 may include a display 408, communication circuitry 405, at least one processor 407, and memory 406.

The at least one processor 407 may include a hardware component for processing data by using instructions stored in the memory 406. The hardware component for processing data may include a central processing unit (CPU) (e.g., including processing circuitry). The hardware component for processing data may include a graphic processing unit (GPU) (e.g., including processing circuitry). The hardware component for processing data may include a display processing unit (DPU) (e.g., including processing circuitry).

The at least one processor 407 may include one or more cores. For example, the at least one processor 407 may have a structure of a multi-core processor such as a dual core, a quad core, or a hexa core.

The memory 406 may include a hardware component for storing data and/or instructions input to the at least one processor 407 and/or output from the at least one processor 407. The memory 406 may include, for example, a volatile memory such as a random-access memory (RAM), and/or a non-volatile memory such as a read-only memory (ROM). The volatile memory may include, for example, at least one of a dynamic RAM (DRAM), a static RAM (SRAM), a cache RAM, and a pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disc, and an embedded multimedia card (EMMC).

The communication circuitry 405 may include a hardware component for supporting transmission and/or reception of a signal between an electronic device (e.g., the second external electronic device 400) and an external electronic device. The communication circuitry 405 may include, for example, at least one of a modem, an antenna, and an optic/electronic (O/E) converter. Communication circuitry 405 may support transmission and/or reception of a signal based on various types of protocols such as ethernet, local area network (LAN), wide area network (WAN), wireless fidelity (WiFi), Bluetooth, Bluetooth low energy (BLE), zigbee, long term evolution (LTE), and 5G new radio (NR).

The display 408 may output visualized information. For example, the display 408 may output, to a user, visualized information in accordance with control of the at least one processor 407. The display 408 may include a hardware component of an electronic device (e.g., the second external electronic device 400) used to display a screen. For example, the display 408 may include light emitting elements and circuits (e.g., transistors) controlling the light emitting elements to emit light. For example, each of the light emitting elements may include an organic light emitting diode (OLED) or a micro LED. However, it is not limited thereto. For example, the display 408 may include a liquid crystal display (LCD).

The at least one processor 407 may sequentially display a first video 711 or a second video 811 via the display 408. For example, while displaying the second video 811, the at least one processor 407 may display, via the display 408, a UI object (e.g., a UI object 835 of FIG. 8) including information associated with a visual object (a visual object 715 of FIG. 7), based on a user input regarding a visual indication (e.g., a visual indication 714 of FIG. 7) included on the second video 811.

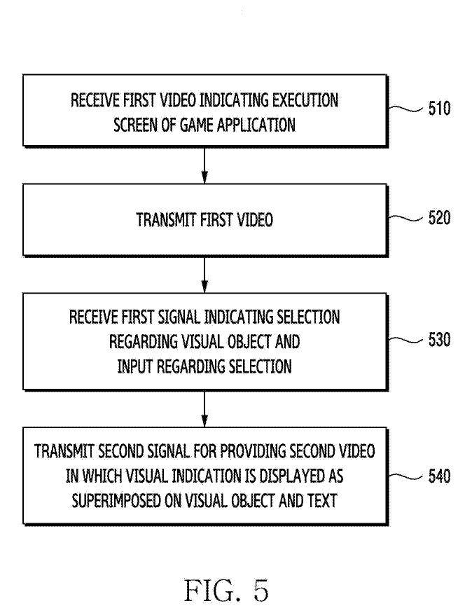

FIG. 5 is a flowchart representing an operation of an electronic device transmitting a signal causing that a visual indication is displayed. This method may be executed by the electronic device 200 or the at least one processor 207 of the electronic device 200 illustrated in FIG. 2.

Referring to FIG. 5, in operation 510, the electronic device 200 may receive, from a first external electronic device 110 via communication circuitry 205, a first video (e.g., a first video 711 of FIG. 7) indicating an execution screen of a game application being executed via the first external electronic device 110. For example, the electronic device 200 may be used to provide a streaming service. For example, while executing the game application, the first external electronic device 110 may display, via a display 308, the first video (e.g., the first video 711 of FIG. 7) indicating the execution screen of the game application. For example, in order to provide the streaming service, the first external electronic device 110 may transmit the first video, to a second external electronic device 400 via the electronic device 200. For example, the streaming service may be described as a service transmitting, to the second external electronic device 400, a screen displayed via the first external electronic device 110. For example, the streaming service may be described as a service enjoying reactions of viewers regarding a screen displayed via the first external electronic device 110.

In operation 520, while receiving the first video (e.g., the first video 711 of FIG. 7), the electronic device 200 may transmit the first video to the second external electronic device 400 via the communication circuitry 205. For example, the first video may be transmitted or streamed, via the electronic device 200, from the first external electronic device 110 to the second external electronic device 400.

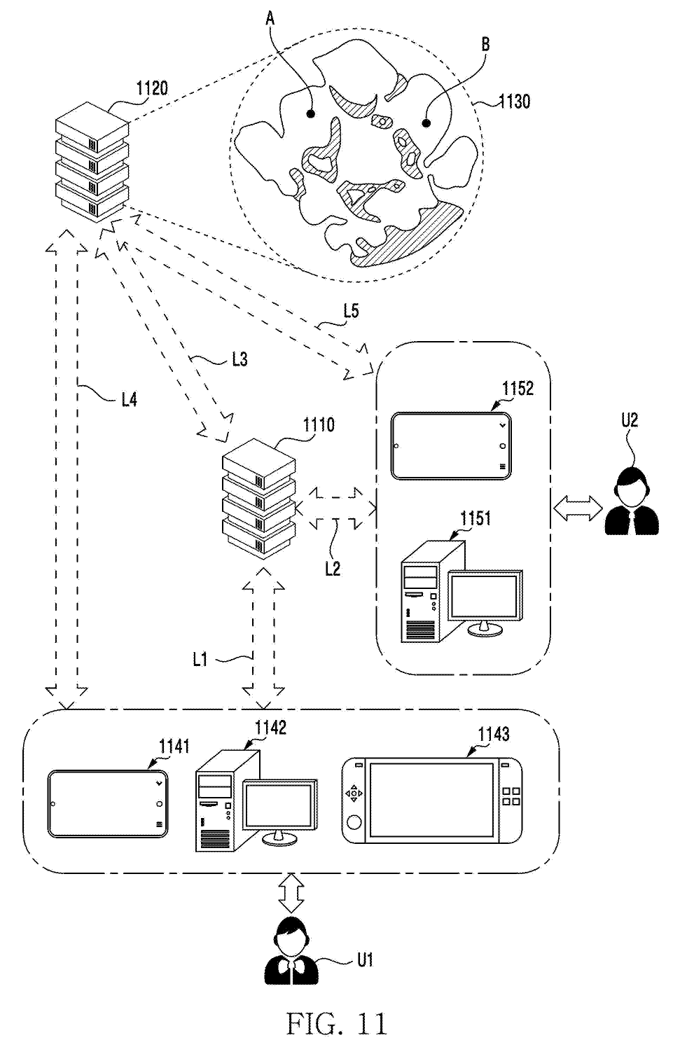

According to an embodiment, although an operation in which the electronic device 200 receives the first video (e.g., the first video 711 of FIG. 7) from the first external electronic device 110 has been described above, an embodiment of the present disclosure is not limited thereto. For example, the first video may be received from an external electronic device (e.g., a server 1110 of FIG. 11) for executing the game application.

In operation 530, while transmitting the first video (e.g., the first video 711 of FIG. 7), the electronic device 200 may receive, from the second external electronic device 400 via the communication circuitry 205, a signal indicating a selection regarding a visual object (e.g., a visual object 715 of FIG. 7) represented by the first video (e.g., the first video 711 of FIG. 7) and an input regarding the selection. For example, the selection may be described as a selection regarding a visual object (e.g., the visual object 715 of FIG. 7) included on an execution screen of the first video (e.g., the first video 711 of FIG. 7). For example, the input may be described as a user input received together with the selection. For example, the input may include a text input. For example, while displaying, via the display 308, the first video (e.g., the first video 711 of FIG. 7) received from the electronic device 200, the second external electronic device 400 may receive an input regarding the selection. For example, based on the reception, the second external electronic device 400 may transmit, to the electronic device 200, a signal indicating the input.

According to an embodiment, based on receiving a signal indicating a selection regarding the visual object (e.g., the visual object 715 of FIG. 7) represented by the first video and an input regarding the selection, the electronic device 200 may identify a region on the first video in which the visual object determined in accordance with the selection is represented. For example, based on combining or compositing a visual indication (e.g., a visual indication 714 of FIG. 7) on the region, the electronic device 200 may generate a second video (e.g., a second video 811 of FIG. 8) in which the visual indication is displayed as superimposed on the visual object. Although an operation in which generation of the second video is performed in the electronic device 200 has been described above, an embodiment of the present disclosure is not limited thereto. For example, the generation of the second video may be performed via the electronic device (e.g., the server 1110 of FIG. 11) for executing the game application.

In operation 540, based on receiving a signal indicating a selection regarding a visual object (e.g., the visual object 715 of FIG. 7) and an input regarding the selection, the electronic device 200 may transmit, to the second external electronic device 400 via the communication circuitry 205, a signal for providing the second video (e.g., the second video 811 of FIG. 8) in which the visual indication (e.g., the visual indication 714 of FIG. 7) indicating the selection is displayed as superimposed on the visual object and text in accordance with the input. For example, based on receiving the signal, the electronic device 200 may transmit, to the first external electronic device 110 and/or the second external electronic device 400, a signal causing that a visual indication (e.g., the visual indication 714 of FIG. 7) is displayed as superimposed on the first video (e.g., the first video 711 of FIG. 7) displayed via the first external electronic device 110. For example, the visual indication may indicate a selection identified via the second external electronic device 400. For example, the visual indication may be used to indicate a position of a visual object (e.g., the visual object 715 of FIG. 7) on the first video (e.g., the first video 711 of FIG. 7).

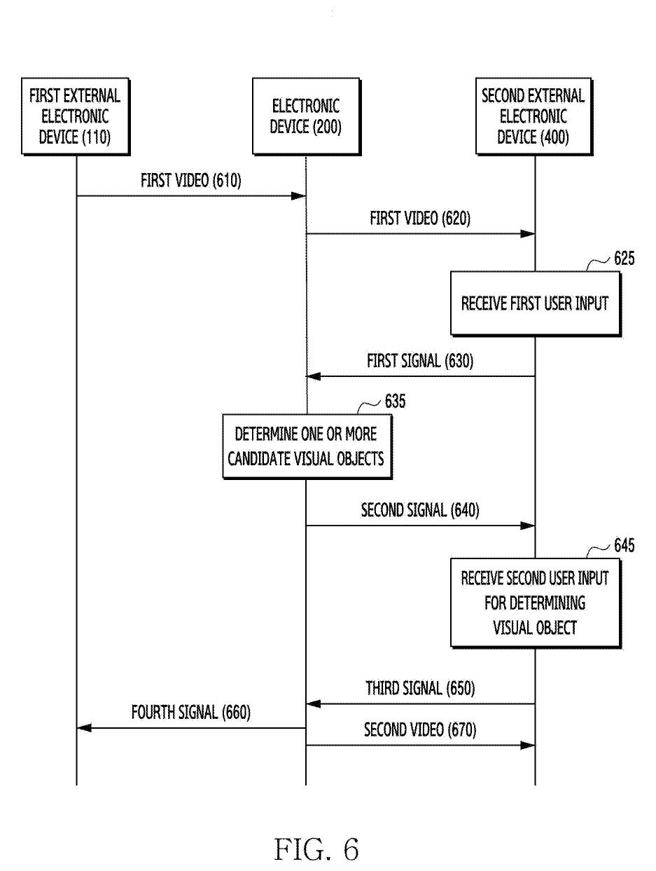

According to an embodiment, based on receiving the signal, the electronic device 200 may transmit, to the second external electronic device 400 via communication circuitry 205, a signal causing that a UI object (e.g., a UI object 722 of FIG. 7) for checking a visual object (e.g., the visual object 715 of FIG. 7) is displayed. For example, the display of the UI object will be described and exemplified in more detail with reference to FIGS. 6 and 7.

FIG. 6 illustrates an example of operations executed in an electronic device, a first external electronic device, and a second external electronic device.

Referring to FIG. 6, in operation 610, while executing a game application, a first external electronic device 110 may transmit, to an electronic device 200 via communication circuitry 305, a first video (e.g., a first video 711 of FIG. 7) indicating an execution screen of the game application. The electronic device 200 may receive, from the first external electronic device 110 via communication circuitry 205, the first video. Although an operation of transmitting or streaming a video indicating the execution screen of the game application has been described above, an embodiment of the present disclosure is not limited thereto. For example, the first external electronic device 110 may transmit or stream a content (e.g., an image, a video, or an audio signal) of a software application different from the game application. For example, the operation 610 of FIG. 6 may correspond to the operation 510 of FIG. 5.

In operation 620, based on receiving the first video (e.g., the first video 711 of FIG. 7), the electronic device 200 may transmit or stream, to a second external electronic device 400 via the communication circuitry 205, the first video. For example, the operation 620 of FIG. 6 may correspond to the operation 520 of FIG. 5.

In operation 625, based on receiving the first video, the second external electronic device 400 may display, via a display 408, the first video. For example, while displaying the first video, the second external electronic device 400 may receive a first user input selecting a visual object (e.g., a visual object 715 of FIG. 7) on the first video. For example, the first user input may be described as a user input selecting one of visual objects (e.g., visual objects 724, 726, and 728 of FIG. 7) included in a UI object (e.g., a UI object 722 of FIG. 7). For example, the selection will be described below with reference to FIG. 7.

In operation 630, the second external electronic device 400 may transmit, to the electronic device 200 via communication circuitry 405, a first signal indicating the first user input. For example, based on receiving the first user input, the second external electronic device 400 may transmit the first signal. For example, based on receiving the first user input, the second external electronic device 400 may transmit, to the electronic device 200 via the communication circuitry 405, an image frame of the first video (e.g., the first video 711 of FIG. 7), which is being displayed via the display 408 when the first user input is received. For example, based on receiving the first user input, the second external electronic device 400 may capture the image frame of the first video. For example, the first signal may further indicate the image frame.

According to an embodiment, the first signal may indicate a region of interest (e.g., a region of interest 718 of FIG. 7) associated with the first user input. For example, object recognition regarding the region of interest may be performed. For example, the object recognition regarding the region of interest will be described below with reference to FIG. 7.

In operation 635, based on receiving the first signal, the electronic device 200 may determine one or more candidate visual objects (e.g., the visual objects 724, 726, and 728 of FIG. 7). For example, based on receiving the first signal, the electronic device 200 may perform object recognition regarding the image frame indicated by the first signal. For example, based on the object recognition, the electronic device 200 may identify visual objects (e.g., the visual objects 724, 726, and 728 of FIG. 7) included in the image frame.

According to an embodiment, when a user of the second external electronic device 400 selects a visual object included in the first video (e.g., the first video 711 of FIG. 7), the second external electronic device 400 may be required to display a UI object (e.g., the UI object 722 of FIG. 7) for checking an intention of the user, in order to prevent selection differently from the intention of the user. For example, the electronic device 200 may be required to determine one or more candidate visual objects to be included in the UI object, by performing the object recognition regarding the image frame.

According to an embodiment, the electronic device 200 may identify one or more visual objects included in the image frame, by performing the object recognition regarding the image frame. For example, the one or more visual objects included in the image frame may include an object associated with an in-game content. For example, the object associated with the in-game content may indicate an in-game item, an avatar, a mini-map, an object for movement of an avatar, an object for activation of a skill, an item quick slot, a health bar of an avatar, and a mana bar of an avatar. However, an embodiment of the present disclosure is not limited thereto.

According to an embodiment, the electronic device 200 may include information regarding a visual object of the game application. For example, the electronic device 200 may store the information in memory 206. For example, the electronic device 200 may determine or identify an identifier of a visual object identified from the image frame, by using the information. For example, by determining the identifier, the electronic device 200 may determine a function (e.g., activation of an item or activation of a skill) corresponding to the visual object identified from the image frame. For example, by matching a first visual object identified via the information with a second visual object identified via the image frame, the electronic device 200 may identify or determine a function corresponding to the second visual object.

According to an embodiment, by performing object recognition regarding a region of interest (e.g., the region of interest 718 of FIG. 7) in the image frame, the electronic device 200 may determine one or more candidate visual objects. For example, the electronic device 200 may perform object recognition regarding the image frame of the first video (e.g., the first video 711 of FIG. 7). For example, a first time required to perform object recognition regarding the entire image frame may be longer than a second time required to perform object recognition regarding the region of interest (e.g., the region of interest 718 of FIG. 7) included in the image frame. For example, as the electronic device 200 performs object recognition only regarding the region of interest, a time required to determine the one or more candidate visual objects may be reduced.

In operation 640, based on determining the one or more candidate visual objects to be included on the UI object (e.g., the UI object 722 of FIG. 7), the electronic device 200 may transmit, to the second external electronic device 400 via the communication circuitry 205, a second signal causing that the UI object is displayed. For example, the display of the UI object will be described below with reference to FIG. 7.

In operation 645, based on receiving the second signal, the second external electronic device 400 may display the UI object (e.g., the UI object 722 of FIG. 7) including the one or more candidate visual objects. For example, while displaying the UI object, the second external electronic device 400 may receive a second user input for determining a visual object (e.g., the visual object 715 of FIG. 7). For example, the second user input may be described as a user input for determining the visual object from among the one or more candidate visual objects by the user of the second external electronic device 400.

In operation 650, based on receiving the second user input, the second external electronic device 400 may transmit, to the electronic device 200 via the communication circuitry 405, a third signal indicating the second user input.

In operation 660, based on receiving the third signal, the electronic device 200 may transmit, to the first external electronic device 110 via the communication circuitry 205, a fourth signal causing that a visual indication (e.g., a visual indication 714 of FIG. 7) indicating a selection of the visual object is displayed as superimposed on the visual object (e.g., the visual object 715 of FIG. 7) indicated by the second user input. For example, based on receiving the fourth signal, the first external electronic device 110 may display the visual indication (e.g., the visual indication 714 of FIG. 7) as superimposed on the visual object (e.g., the visual object 715 of FIG. 7). For example, the display of the visual indication will be described below with reference to FIG. 8.

According to an embodiment, the electronic device 200 may transmit, via the communication circuitry 205, to an external electronic device (e.g., a server) for providing the game application being executed in the first external electronic device 110, a signal causing that a second video (e.g., a second video 811 of FIG. 8) on which the visual indication (e.g., the visual indication 714 of FIG. 7) is displayed as superimposed is transmitted. For example, the external electronic device for providing the game application may be referred to as a game server. For example, based on receiving the third signal, the electronic device 200 may transmit, to the game server via the communication circuitry 205, a signal causing that the second video (e.g., the second video 811 of FIG. 8) on which the visual indication is displayed is transmitted to the first external electronic device 110. For example, the first external electronic device 110 may receive, from the game server via the communication circuitry 305, the second video in which the visual indication is displayed as superimposed on the visual object (e.g., the visual object 715 of FIG. 7). For example, based on the reception, the first external electronic device 110 may display, via a display 308, the second video.

According to an embodiment, the first external electronic device 110 may receive, from the electronic device 200 via the communication circuitry 205, the signal causing that the visual indication (e.g., the visual indication 714 of FIG. 7) is displayed as superimposed on the visual object (e.g., the visual object 715 of FIG. 7). For example, the signal may cause that information (e.g., content information 832 or a link 836 of FIG. 8) associated with the visual object is displayed in accordance with a user input received via the first external electronic device 110 regarding the visual indication. For example, the information may be determined via a trained model (e.g., an artificial intelligence model) for recommending a media content regarding the game application, and may include a link (e.g., the link 836 of FIG. 8) indicating a media content associated with the visual object (e.g., the visual object 715 of FIG. 7). For example, the information may be obtained from the second external electronic device 400, and may include text indicated by an input regarding a selection regarding the visual object. For example, provision of the information will be described below with reference to FIG. 8.

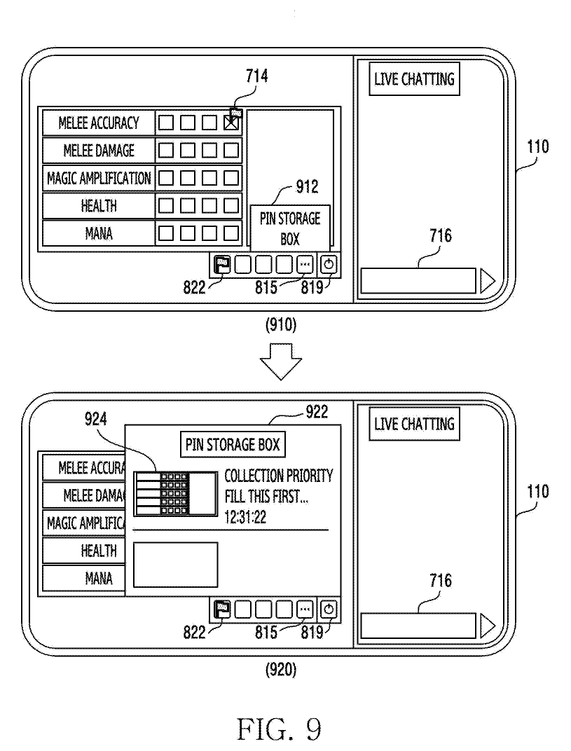

According to an embodiment, the electronic device 200 may transmit, to the first external electronic device 110 via the communication circuitry 205, a signal causing that a visual representation (e.g., a visual representation 822 of FIG. 8) for notifying the selection regarding the visual object (e.g., the visual object 715 of FIG. 7) is displayed outside the execution screen of the game application. For example, the signal may cause that a UI object (e.g., a UI object 922 of FIG. 9) including an image frame (e.g., an image frame 924 of FIG. 9) included in the first video (e.g., the first video 711 of FIG. 7) and text is displayed, in accordance with a user input received via the first external electronic device 110 regarding the visual representation.

In operation 670, based on receiving the third signal, the electronic device 200 may transmit, to the second external electronic device 400, the second video (e.g., the second video 811 of FIG. 8). For example, the second video may be received from the first external electronic device 110. However, an embodiment of the present disclosure is not limited thereto. For example, the second video may be obtained or received from the game server.

According to an embodiment, the electronic device 200 may transmit, to the second external electronic device 400 via the communication circuitry 205, a signal causing that the second video (e.g., the second video 811 of FIG. 8) is displayed on a streaming region 130, and text indicated by an input received from the second external electronic device 400 is displayed on a chatting region 140. For example, the streaming region 130 may be described as a region for displaying a streamed video (or image). For example, the chatting region 140 may be described as a region arranged associated with the streaming region 130 and for displaying text identified via the second external electronic device 400.

According to an embodiment, while displaying the first video (e.g., the first video 711 of FIG. 7), the second external electronic device 400 may receive the first user input selecting the visual object (e.g., the visual object 715 of FIG. 7) included in the first video. For example, based on receiving the first user input, the second external electronic device 400 may display the UI object (e.g., the UI object 722 of FIG. 7) including the one or more candidate visual objects. For example, the display of the UI object will be described and exemplified in more detail with reference to FIG. 7.

FIG. 7 illustrates an exemplary operation of a second external electronic device selecting a visual object.

Referring to FIG. 7, a state 710 may be described as a state in which a first video 711 is displayed via a second external electronic device 400. For example, based on receiving the first video 711 from an electronic device 200, the second external electronic device 400 may display the first video 711 via a display 408. For example, the second external electronic device 400 may display via, the display 408, an executable object 712 together with the first video 711. For example, based on receiving an input regarding the executable object 712, the second external electronic device 400 may activate a function capable of selecting a visual object included in the first video 711. For example, the function may be described as a function capable of inputting text together with selecting the visual object included in the first video 711. For example, the function may be referred to as a pin comment function. For example, after executing the pin comment function in accordance with the input regarding the executable object 712, the second external electronic device 400 may receive an input selecting a visual object 715 being displayed via the display 408. The visual object 715 may indicate at least one of an in-game item, a skill, a mini-map, a monster, and/or a user interface.

Based on receiving the input selecting the visual object 715, the second external electronic device 400 may display a visual indication 714 indicating the selection. For example, the second external electronic device 400 may display the visual indication 714 as superimposed on the visual object 715. For example, the visual indication 714 may be used to guide or indicate a visual object specified by a user of the second external electronic device 400.

According to an embodiment, based on receiving the input selecting the visual object 715, the second external electronic device 400 may transmit, to the electronic device 200 via communication circuitry 405, an image frame being displayed via the display 408 when the input is received. For example, based on receiving the image frame, by performing object recognition regarding the image frame, the electronic device 200 may identify information (e.g., item information in a game application, and the like) regarding the visual object 715. For example, based on the object recognition, the electronic device 200 may determine candidate visual objects associated with the visual object 715. For example, the electronic device 200 may identify content information (e.g., content information 832 of FIG. 8) corresponding to the visual object 715, by performing the object recognition regarding the image frame.

According to an embodiment, although the visual indication 714 indicating the selection regarding the visual object 715 has been described above, an embodiment of the present disclosure is not limited thereto. For example, the visual indication 714 may be used to indicate a position (or a region) on the first video 711. For example, the position may be described as a position indicated by a user input received via the second external electronic device 400.

According to an embodiment, based on receiving an input regarding the visual object 715, the second external electronic device 400 may identify a region of interest 718 including the visual object 715. For example, the second external electronic device 400 may transmit, to the electronic device 200 via the communication circuitry 405, data indicating a region of interest together with a signal indicating the input. For example, based on receiving the signal, the electronic device 200 may determine one or more candidate visual objects to be included in a UI object 722 by performing object recognition regarding the region of interest 718.

According to an embodiment, based on transmitting the first video 711 to the second external electronic device 400, the electronic device 200 may receive, from the second external electronic device 400 via communication circuitry 205, a signal indicating the region of interest 718 on the first video 711. The region of interest 718 may be described as a region determined in accordance with the user input received via the second external electronic device 400. For example, the electronic device 200 may determine one or more candidate visual objects associated with a game application, by performing the object recognition regarding the region of interest 718. For example, the electronic device 200 may transmit, to the second external electronic device 400 via the communication circuitry 205, another signal causing that the UI object 722 including the one or more candidate visual objects is displayed. For example, based on transmitting the another signal, the electronic device 200 may receive, from the second external electronic device 400 via the communication circuitry 205, a signal indicating the selection regarding the visual object 715 and an input associated with the selection, from among the one or more candidate visual objects.

A state 720 may be described as a state in which the UI object 722 including visual objects 724, 726, and 728 is displayed. For example, based on receiving an input indicating the selection regarding the visual object 715, the second external electronic device 400 may display the UI object 722 via the display 408. For example, the UI object 722 may be displayed as superimposed on the first video 711. However, an embodiment of the present disclosure is not limited thereto.

While displaying the UI object 722, the second external electronic device 400 may receive a second user input selecting one of the visual objects 724, 726, and 728. For example, based on receiving the second user input, the second external electronic device 400 may transmit, to the electronic device 200 via the communication circuitry 405, a signal (e.g., the third signal of FIG. 6) indicating the second user input.

A state 730 may be described as a state in which text is obtained based on a visual element 716 after the second user input is received. For example, after receiving the second user input, the second external electronic device 400 may receive a text input. For example, the text input may be received via the visual element 716 on a chatting region 140. For example, the text obtained via the visual element 716 may include text associated with the visual object 715. For example, a user of the second external electronic device 400 may provide an opinion of a user 120 regarding the visual object 715, by using the selection regarding the visual object 715 and the text based on the visual element 716. For example, since the second external electronic device 400 provides, to the first external electronic device 110 via the electronic device 200, the selection regarding the visual object 715 and the text associated with the visual object 715, an effect of communication in a streaming service may be increased. For example, since the user 120 immediately checks and reacts to a pin comment caused from the user of the second external electronic device 400, immersion of viewers may be increased.

The first external electronic device 110 may display the first video 711 via a display 308 to provide the streaming service. For example, based on a user input received from the second external electronic device 400, the first external electronic device 110 may display, via the display 308, a second video (e.g., a second video 811 of FIG. 8) in which the visual indication 714 is displayed as superimposed on the visual object 715. For example, the display of the second video will be described and exemplified in more detail with reference to FIG. 8.

FIG. 8 illustrates an exemplary operation of a first external electronic device displaying information associated with a visual object.

Referring to FIG. 8, a state 810 may be described as a state in which a first video 711 is displayed to provide a streaming service. For example, while displaying the first video 711, a first external electronic device 110 may transmit or stream the first video 711 to an electronic device 200 or a second external electronic device 400 via communication circuitry 305.

The first external electronic device 110 may display, via a display 308, an executable object 819 together with the first video 711. For example, based on receiving an input regarding the executable object 819, the first external electronic device 110 may execute a pin comment function. For example, the first external electronic device 110 may be referred to as a host electronic device. For example, when executing the pin comment function, the first external electronic device 110 may display a visual indication 714 caused from the second external electronic device 400.

A state 820 may be described as a state in which the visual indication 714 is displayed as superimposed on a visual object 715 in accordance with a selection caused from the second external electronic device 400. For example, based on receiving a signal (e.g., the fourth signal of FIG. 6) causing that the visual indication 714 is displayed as superimposed on the visual object 715, the first external electronic device 110 may display, via the display 308, a second video 811 in which the visual indication 714 is displayed as superimposed on the visual object 715.

According to an embodiment, although an operation in which the second video 811 is displayed via the first external electronic device 110 in the state 820 has been described above, an embodiment of the present disclosure is not limited thereto. For example, based on receiving the signal causing that the visual indication 714 is displayed as superimposed on the visual object 715, the first external electronic device 110 may display the visual indication 714 as superimposed on the first video 711 indicating an execution screen of a game application. For example, a screen displayed via the first external electronic device 110 may be described as an execution screen of the game application in which the visual indication 714 is displayed as superimposed on the visual object 715. For example, a screen displayed via the second external electronic device 400 may be described as a screen in which the visual indication 714 is composited as superimposed on the visual object 715.

According to an embodiment, based on receiving the signal (e.g., the fourth signal of FIG. 6) causing that the visual indication 714 is displayed, the first external electronic device 110 may display a visual representation 822 for notifying a selection regarding the visual object 715 received via the second external electronic device 400. For example, when an execution screen that does not include the visual object 715 of the first external electronic device 110 is displayed via the display 308, a user 120 may recognize that a pin comment is obtained based on the visual representation 822. For example, the pin comment may be described as a function in which the visual indication 714 indicating the selection regarding the visual object 715 is displayed based on a user input received from the second external electronic device 400.

According to an embodiment, based on receiving the signal (e.g., the fourth signal of FIG. 6) causing the visual indication 714 is displayed, the first external electronic device 110 may display, via the display 308, a window 828 for notifying the selection regarding the visual object 715 received via the second external electronic device 400. For example, the window 828 may be displayed on a chatting region 140. However, an embodiment of the present disclosure is not limited thereto. For example, as the window 828 is displayed on the chatting region 140, viewers may recognize existence of the pin comment via the window 828. For example, based on receiving the signal, the first external electronic device 110 may perform at least one of display of the visual indication 714, display of the visual representation 822, and/or display of the window 828.

A state 830 may be described as a state in which a UI object 835 including information associated with the visual object 715 is displayed. For example, the first external electronic device 110 may receive a user input regarding at least one of the visual indication 714, the visual representation 822, and/or the window 828. For example, based on receiving the user input regarding the at least one, the first external electronic device 110 may display, via the display 308, the UI object 835 including the information associated with the visual object 715. For example, the UI object 835 may include at least one of a nickname indicating a user of the second external electronic device 400, text 834 obtained associated with the visual object 715, in-game content information 832 corresponding to the visual object 715, and a link 836.

The in-game content information 832 corresponding to the visual object 715 may include at least one of a name of an in-game item, a price, and/or a thumbnail image of the item. However, an embodiment of the present disclosure is not limited thereto.

The link 836 may be described as a link indicating a media content associated with the in-game content information 832 corresponding to the visual object 715. For example, the media content may be determined via an artificial intelligence model (not illustrated). For example, the artificial intelligence model may be described as a trained model for determining a media content recommended from among media contents, by using the content information 832 and/or the text 834. For example, the artificial intelligence model may include a model trained via a machine learning (or deep learning) technique. For example, the artificial intelligence model may be included in the electronic device 200. For example, when transmitting, to the first external electronic device 110, the signal (e.g., the fourth signal of FIG. 6) causing that the visual indication 714 is displayed, the electronic device 200 may transmit information to be included in the UI object 835 together. For example, based on receiving the information, the first external electronic device 110 may display, via the display 308, the UI object 835 including at least one of the text 834, the content information 832, and/or the link 836.

For example, based on the link 836, the user 120 of the first external electronic device 110 may search various media contents associated with the content information 832. For example, in accordance with the link 836, viewers of a streaming service may easily and concisely provide information to the user 120 of the first external electronic device 110. For example, the user 120 may easily and conveniently recognize information associated with a video being streamed by using the link 836. For example, since media contents are provided in accordance with the link 836, a time in which a content is consumed in a platform providing the game application may increase.

According to an embodiment, although an operation in which the UI object 835 is displayed via the first external electronic device 110 has been described above, an embodiment of the present disclosure is not limited thereto. For example, the UI object 835 may be displayed via each of external electronic devices (e.g., the second external electronic device 400) corresponding to viewers of the streaming service.

By obtaining the pin comment, the first external electronic device 110 may display a UI object (e.g., a UI object 922 of FIG. 9) for obtaining the pin comment. For example, the display of the UI object will be described and exemplified in more detail with reference to FIG. 9.

FIG. 9 illustrates an exemplary operation of a first external electronic device displaying a UI object for managing a comment.

A state 910 may be described as a state in which an executable object 912 for browsing a pin comment is displayed. For example, based on receiving an input regarding an executable object 815, a first external electronic device 110 may display the executable object 912 via a display 308. For example, based on receiving an input regarding the executable object 912, the first external electronic device 110 may display, via the display 308, a UI object 922 for browsing the pin comment.

A state 920 may be described as a state in which the UI object 922 including summary information regarding the pin comment is displayed. For example, based on receiving a user input regarding the executable object 912, the first external electronic device 110 may display the UI object 922 via the display 308. For example, when a user input selecting a visual object 715 is received, the UI object 922 may include an image frame 924 displayed via a second external electronic device 400. For example, the UI object 922 may indicate text indicated by the user input selecting the visual object 715. For example, the UI object 922 may indicate a time at which a signal causing that the visual indication 714 is displayed is received.

According to an embodiment, based on receiving a user input regarding the UI object 922 in the state 920, the first external electronic device 110 may display, via the display 308, the UI object 835 of the state 830.

According to an embodiment, the UI object 922 may include summary text. For example, the summary text may be obtained from the second external electronic device 400, and may be described as text in which text associated with a selection regarding the visual object 715 is summarized. For example, an electronic device 200 may obtain summary text (e.g., "Collection priority") from text associated with the selection (e.g., "It would be good to fill this collection first."), by using a language model (not illustrated). For example, the language model may include a large language model (LLM).

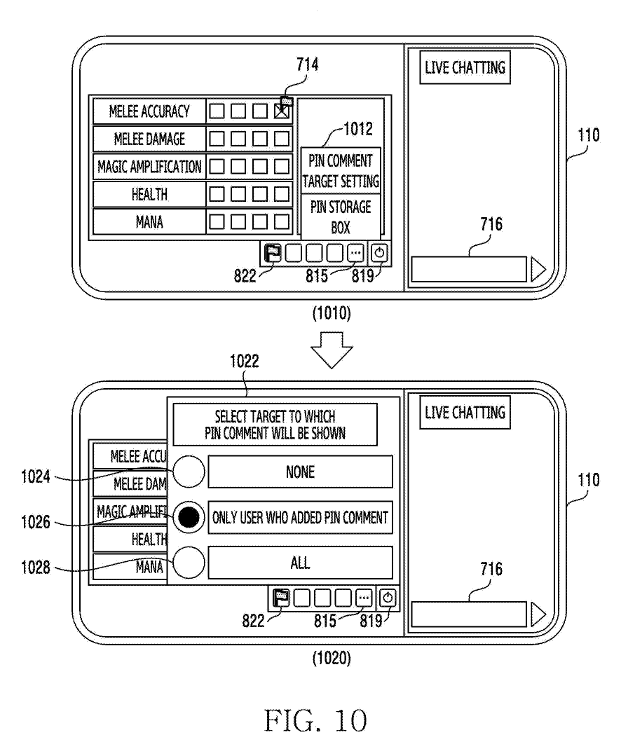

The first external electronic device 110 may receive a user input for determining an external electronic device to which a second video is to be transmitted. For example, the first external electronic device 110 may transmit, to the electronic device 200 via communication circuitry 305, a signal indicating the user input. For example, based on the user input received via the first external electronic device 110, the electronic device 200 may determine, from among a plurality of external electronic devices, an external electronic device to which the second video is to be transmitted. For example, the determination of the external electronic device to which the second video is to be transmitted based on the user input will be described and exemplified in more detail with reference to FIG. 10.

FIG. 10 illustrates an exemplary operation of a first external electronic device displaying a UI object for determining an external electronic device to which a second video is to be transmitted.

A state 1010 may be described as a state of displaying an executable object 1012 for determining an external electronic device to which a second video is to be transmitted. For example, based on receiving a user input regarding an executable object 815, a first external electronic device 110 may display, via a display 308, the executable object 1012. For example, when displaying the executable object 1012, the first external electronic device 110 may receive a user input regarding the executable object 1012.

A state 1020 may be described as a state of displaying a UI object 1022 for determining an external electronic device to which the second video is to be transmitted. For example, based on receiving the user input regarding the executable object 1012, the first external electronic device 110 may display, via the display 308, the UI object 1022. For example, the UI object 1022 may be described as a UI object for setting an external electronic device to which a pin comment is applied to be displayed. For example, the UI object 1022 may be described as a UI object for determining an external electronic device on which the second video and/or a UI object 835 is to be displayed. For example, the UI object 1022 may include visual objects 1024, 1026, and 1028 for setting an external electronic device on which the second video and/or the UI object 835 is to be displayed. For example, while displaying the UI object 1022, the first external electronic device 110 may receive a user input regarding one of the visual objects 1024, 1026, and 1028. For example, the first external electronic device 110 may transmit, to an electronic device 200 via communication circuitry 305, a signal indicating the user input.

The electronic device 200 may receive, from the first external electronic device 110 via communication circuitry 205, the signal indicating the user input. For example, based on receiving the signal, the electronic device 200 may identify the user input indicated by the signal. For example, based on a determination that the user input received by the first external electronic device 110 is a first user input regarding the visual object 1024, the electronic device 200 may refrain from, bypass, or block transmitting a signal (e.g., the second signal of the operation 540 of FIG. 5) causing that the second video and/or the UI object 835 is displayed.

For example, based on a determination that the user input received by the first external electronic device 110 is a second user input regarding the visual object 1026, the electronic device 200 may transmit, to a second external electronic device 400 among the second external electronic device 400 and a third external electronic device via the communication circuitry 205, the signal (e.g., the second signal of the operation 540 of FIG. 5) causing that the second video and/or the UI object 835 is displayed. For example, the third external electronic device may be described as an external electronic device to which a first video is transmitted from the electronic device 200. For example, the third external electronic device may be referred to as a viewer's electronic device different from the second external electronic device 400. For example, based on receiving the first video from the first external electronic device 110, the electronic device 200 may transmit, via the communication circuitry 205, the first video to the second external electronic device 400 and the third external electronic device. For example, based on the second user input, the electronic device 200 may refrain from transmitting the second video to the third external electronic device.

For example, based on a determination that the user input received by the first external electronic device 110 is a third user input regarding the visual object 1028, the electronic device 200 may respectively transmit, to the second external electronic device 400 and the third external electronic device via the communication circuitry 205, the signal (e.g., the second signal of the operation 540 of FIG. 5) causing that the second video and/or the UI object 835 is displayed. Although an operation of transmitting, to the second external electronic device 400 and the third external electronic device, the signal causing that the second video and/or the UI object 835 is displayed has been described above, an embodiment of the present disclosure is not limited thereto. For example, the electronic device 200 may transmit, via communication circuitry 205, the signal to each of a plurality of external electronic devices including the second external electronic device 400 and the third external electronic device.

FIG. 11 illustrates an example of a server (e.g., servers 1110 and 1120) and one or more user terminals (e.g., user terminals 1141, 1142, 1143, 1151, and 1152) interconnected for a game service.

A server (e.g., the servers 1110 and 1120) may include a computer designed to provide a function of a server, such as a workstation. An embodiment is not limited thereto, and the server may include a personal computer configured to execute a software application, and/or a combination of the personal computers. The server may include a group (or a cluster) of the exemplified workstations and/or personal computers.

In an embodiment, a service provider may provide or operate an automated service by using a server. The service may include a game service. The game service may be provided for network based playing of a game such as a role playing game (RPG), a massive multi-user online RPG (MMORPG), a first person shooter (FPS), and/or a puzzle. Via the game service, different users (e.g., users of the game service) may be connected to each other via a network, and may cooperate or compete. The server may support or execute a function associated with the game service (e.g., matching of users, provision of a virtual space 1130 such as a battlefield, trading of virtual items such as a market, and/or chatting between users).

Referring to FIG. 11, the servers 1110 and 1120 included in a network to provide different services are illustrated. The server 1110 may be configured to relay a connection of a user with various game services provided via the network (e.g., the game service provided by the server 1120). A service provided via the server 1110 may be referred to as a game platform service, a game launching service, a game publishing service, and/or a game relay service.

Referring to FIG. 11, the server 1110 may cause the server 1120 for providing the game service to provide, to a user of the game platform service, a user experience associated with the game service. The server 1110 may store, in a user database associated with users of the game platform service, information indicating one or more game services to which the users subscribe. The information may further include information for the server 1110 to access another server for a game service, such as the server 1120 (e.g., account information for logging into the game service, and/or authentication information).

Referring to FIG. 11, the server 1110 may store, in a user database, information indicating at least one game service to which users of the game platform service subscribe. The user database may include a record having a user subscribed to the game platform service as a unit. The record may include at least one game service to which the corresponding user subscribes, and/or information for accessing (or logging into) the at least one game service.

Referring to FIG. 11, users U1 and U2 of the game platform service provided by the server 1110 are illustrated. Although the user U1 owning the user terminals 1141, 1142, and 1143, and the user U2 owning the user terminals 1151 and 1152 are illustrated, the number of users of the server 1110 and the number of user terminals owned by each of the users are not limited thereto. A user of the game platform service may be referred to as a user.

Referring to FIG. 11, various appearances of a user terminal (or a user equipment) of a user are illustrated. The user terminal may include a smartphone (e.g., the user terminals 1141 and 1152), a smartpad, and/or a tablet PC. The user terminal may include a personal computer such as a desktop (e.g., the user terminals 1142 and 1151) and a laptop. The user terminal may include a portable gaming device (e.g., the user terminal 1143) and/or a gaming console dedicated to a game service. The user terminal may include a smart accessory such as a smartwatch and/or a head-mounted device (HMD). An embodiment of the user terminal is not limited thereto.

Referring to FIG. 11, the user U1 may access the game platform service provided by the server 1110 by using at least one of the user terminals 1141, 1142, and 1143. Similarly, the user U2 may access the game platform service by using at least one of the user terminals 1151 and 1152. A software application for communicating with the server 1110 may be installed in at least one of the user terminals 1141, 1142, 1143, 1151, and 1152. The software application may be referred to as a game platform application, a game platform program, a game launcher, and/or a client application.

Hereinafter, a connection relationship between the user terminal 1141 and the server 1110 and between the user terminal 1141 and the server 1120 will be described by using, as an example, the user terminal 1141, which is one of the user terminals 1141, 1142, 1143, 1151, and 1152.

For example, by using the user terminal 1141 executing a game launcher, the user U1 may access the game platform service provided by the server 1110. The user terminal 1141 executing the game launcher may establish a communication link L1 between the user terminal 1141 and the server 1110. The communication link L1 may include a logical connection (e.g., a logical connection distinguished by a session) established for data communication between the user terminal 1141 and the server 1110 in a network. Similarly, in response to an input of the user U2 for executing a game launcher of the user terminal 1151, the user terminal 1151 may establish a communication link L2 between the server 1110 and the user terminal 1151.

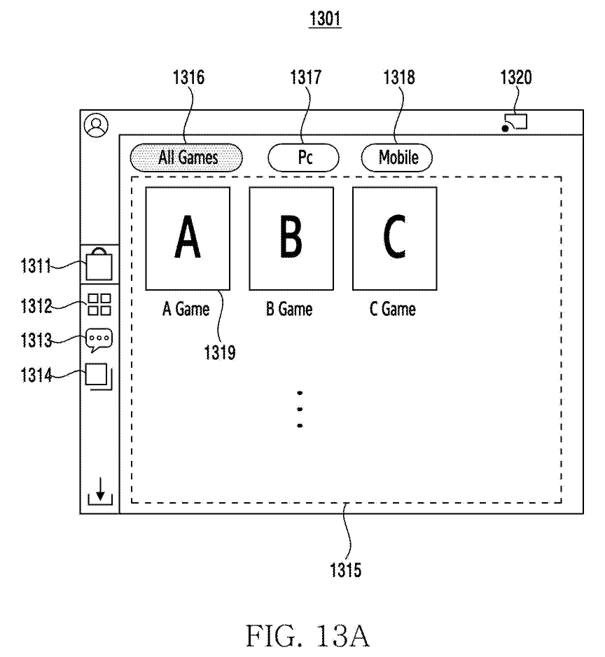

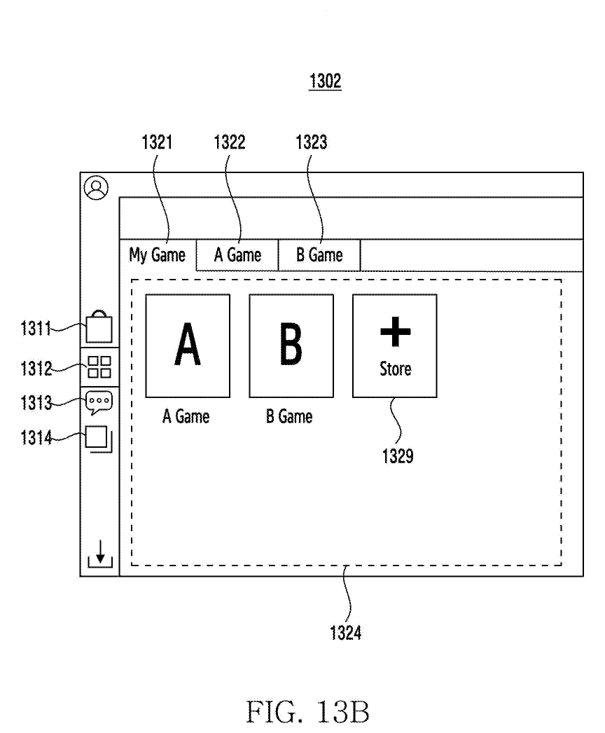

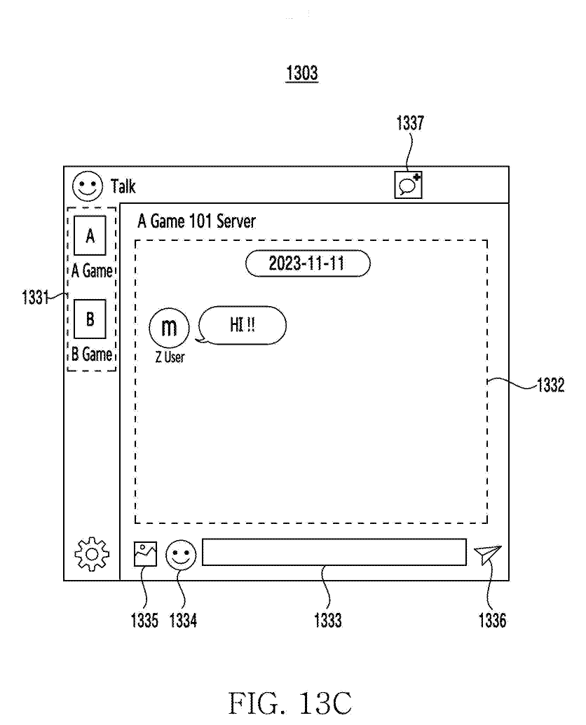

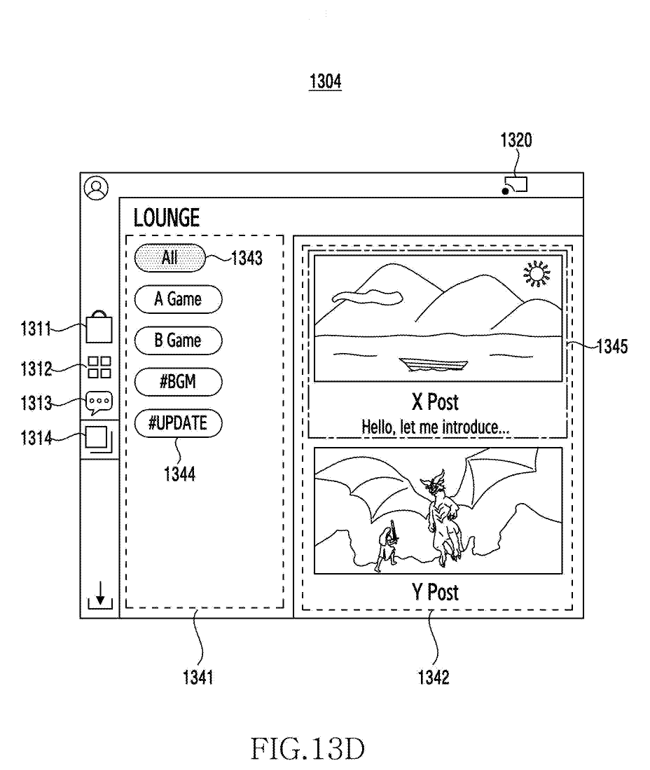

The server 1110 detecting the user terminal 1141 executing the game launcher by using the communication link L1 may check a user account logged into the user terminal 1141. By comparing a user database stored in the server 1110 and authentication information transmitted from the user terminal 1141 (e.g., an ID, a password, a personal identification number (PIN), and/or an one-time password (OTP)), the server 1110 may authenticate the user U1 executing the game launcher in the user terminal 1141. Based on the authentication, the user terminal 1141 may display a screen provided by the game launcher. For example, a state of the user terminal 1141 executing the game launcher may include a state before authenticating the user U1 (e.g., a locked state and/or a state before login), and a state after authenticating the user U1. The screen displayed by the user terminal 1141 and/or a function provided to the user U1 based on the authentication will be described with reference to FIGS. 13A to 13D.

Referring to FIG. 11, in a state in which the users U1 and U2 of the user terminals 1141 and 1151 connected to the server 1110 via the communication links L1 and L2 are authenticated, the server 1110 may support an interaction between the users U1 and U2. For example, the server 1110 may support transmission (e.g., streaming) and/or reception of a message (e.g., a text message), an image, a video, a sound (e.g., a voice chat), and/or a post between the users U1 and U2. The server 1110 configured to provide the game platform service may execute or support functions associated with online activities of the users U1 and U2 associated with a game.

In a state of accessing the game platform service by using the user terminal 1141, the user U1 may access a game service connected to the game platform service. For example, the user terminal 1141 executing the game launcher may receive an input for accessing the game service. In response to the input for accessing the game service detected by using the game launcher, the user terminal 1141 may transmit, to the server 1110 via the communication link L1, a signal associated with the input. The server 1110 receiving the signal may communicate with the server 1120 providing the game service indicated by the signal. For example, by using a communication link L3 established between the servers 1110 and 1120, the server 1110 may transmit information associated with the user U1 logged into the game platform service (e.g., authentication information required for the server 1120 providing the game service to authenticate the user U1). Based on authentication of the user U1 using the information, a communication link L4 between the user terminal 1141 of the user U1 and the server 1120 may be established.

Similarly, from the user terminal 1151 in which the user U2 is logged in, the server 1110 may receive a signal notifying of reception of an input for accessing the game service. The server 1110 receiving the signal may transmit a signal causing that a communication link L5 between the user terminal 1151 and the server 1120 is established, to the server 1120 by using the communication link L2. Via the communication link L5 established by the signal, direct communication between the user terminal 1151 and the server 1120 may be performed. An embodiment is not limited thereto, and indirect communication between the server 1120 providing the game service and the user terminal 1151 may be performed by using the communication links L2 and L3.

As described above, in a state in which the communication links L4 and L5 between the user terminals and the server 1120 are established so that the game service is provided to the user terminals (e.g., the user terminals 1141 and 1151) of each of the users U1 and U2, the server 1120 for providing the game service may transmit, to each of the user terminals, information regarding at least a portion of the virtual space 1130. For example, the server 1120 may transmit, to the user terminal 1141 of the user U1, information associated with a portion of the virtual space 1130 including a position A associated with the user U1 (e.g., information for rendering the portion of the virtual space 1130). For example, the server 1120 may transmit, to the user terminal 1151 of the user U2, information associated with another portion of the virtual space 1130 including a position B associated with the user U2.

Although an exemplary operation in which a user (e.g., the users U1 and U2) accesses the game service by using the server 1110 providing the game platform service has been described, an embodiment is not limited thereto. For example, the user may directly access the server 1120 for the game service without the server 1110, by using a game application installed in a user terminal.

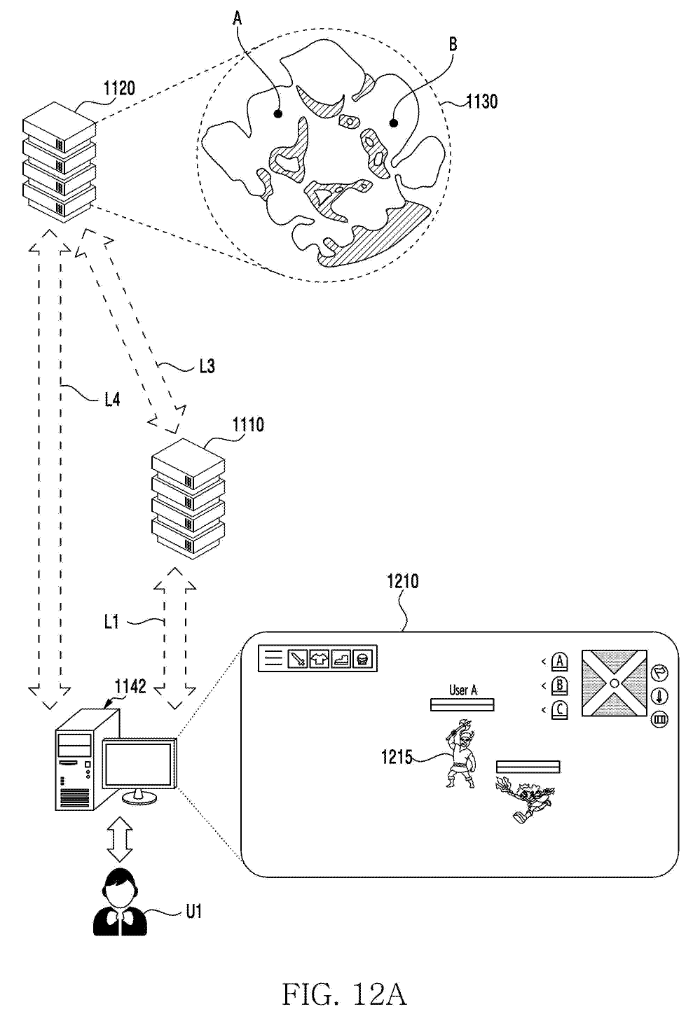

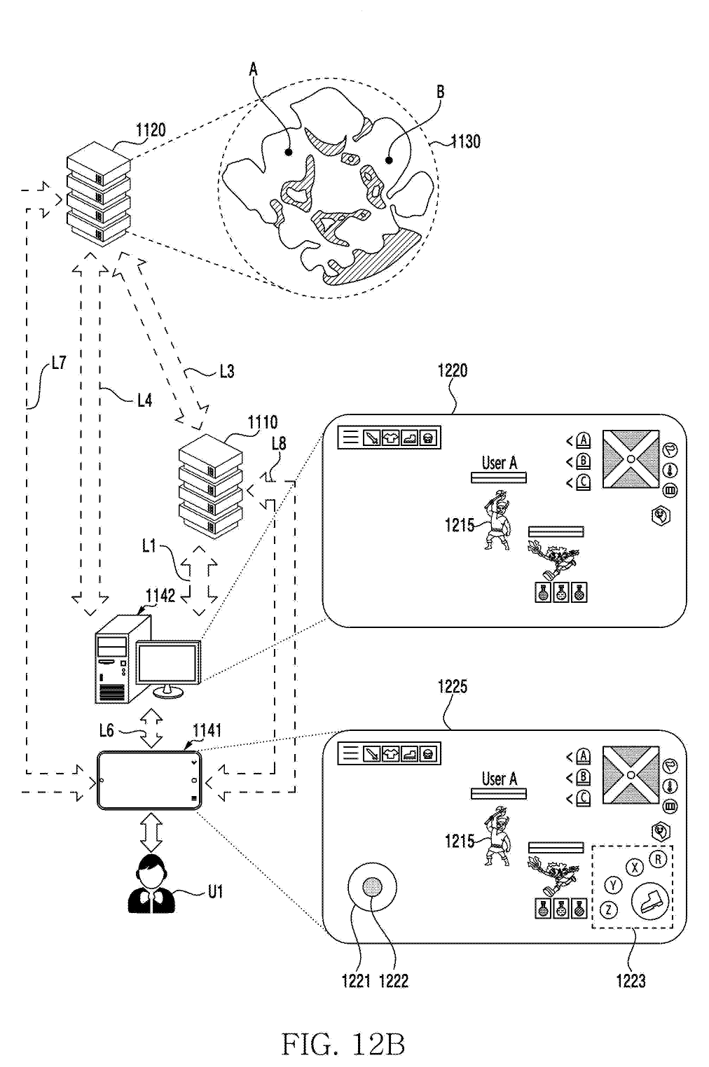

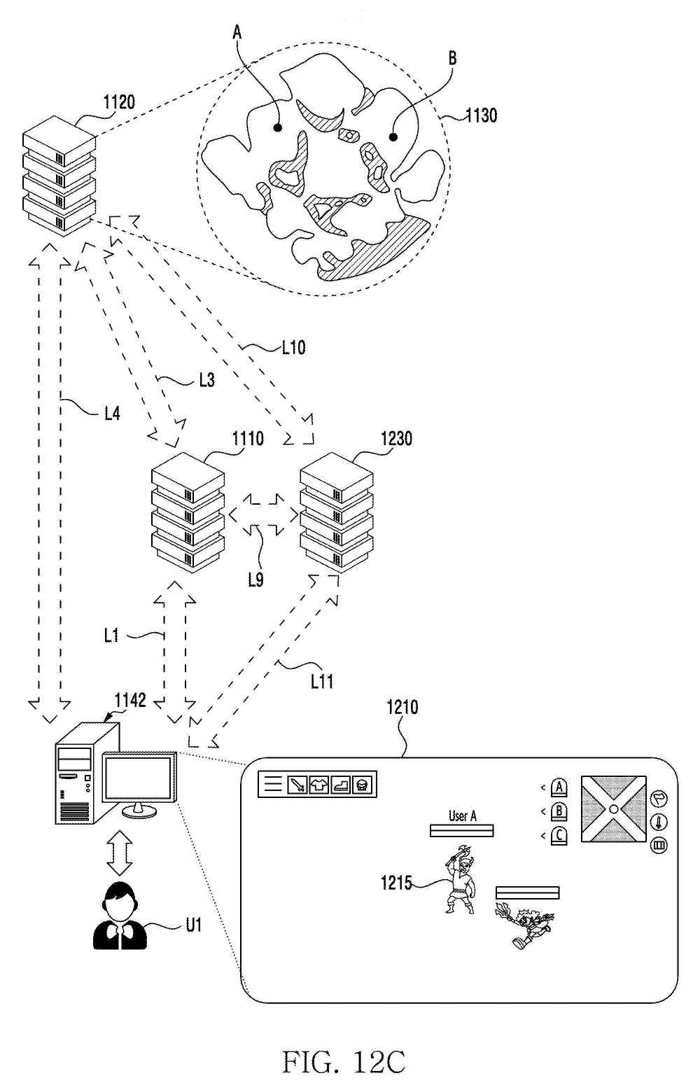

Hereinafter, with reference to FIGS. 12A to 12B, an exemplary operation of a user terminal and/or a server associated with a communication link connected for a game service and/or a game platform service will be described. For example, an exemplary operation of the server 1110 based on the user U1 and the user terminal 1142 is described, but an embodiment is not limited thereto.

FIGS. 12A, 12B, and 12C illustrate exemplary cases of providing a user experience associated with a game by using a plurality of user terminals (e.g., user terminals 1141 and 1142). Referring to FIGS. 12A to 12C, an exemplary state in which communication links L1, L3, and L4 between a server 1110 for a game platform service, a server 1120 for a game service, and a user terminal 1142 are established is illustrated. The server 1110 may communicate with the server 1120 in accordance with the operation described with reference to FIG. 11, and may establish the communication link L4 between the server 1120 and the user terminal 1142. For communication between the server 1110 and the user terminal 1142, a game launcher associated with the game platform service may be executed in the user terminal 1142.

Referring to FIGS. 12A to 12C, in response to an input for executing a game application, the user terminal 1142 executing the game launcher may execute the game application. The user terminal 1142 executing the game application may display a screen 1210 provided from the game application. Although the exemplary screen 1210 including a player character (PC) 1215 controllable by an input received via the user terminal 1142 is illustrated, an embodiment is not limited thereto. By using a signal received from the server 1120 via the communication link L4, the user terminal 1142 may display the screen 1210 including the PC 1215 included in a virtual space 1130.

Referring to FIG. 12A, the user terminal 1142 executing the game application may output the screen 1210 to a user U1, and may receive, from the user U1, an input associated with a game (e.g., an input for controlling the PC 1215). The user terminal 1142 receiving the input may transmit, to the server 1120 via the communication link L4, a first signal indicating the input. The user terminal 1142 may further receive, from the server 1120 via the communication link L4, a second signal indicating a state of the virtual space 1130 and/or the PC 1215 changed by the input. The user terminal 1142 receiving the second signal may at least partially change the screen 1210. For example, the user terminal 1142 may play an animation associated with the PC 1215 in the screen 1210.

When an input for executing the game application is received via the game launcher, the user terminal 1142 may execute the game application in linkage with the game launcher. By using the linkage, the user terminal 1142 may execute a function of the game launcher based on a state of the game application. The function may include an operation of transmitting, to the server 1110, a signal notifying the state (e.g., streaming of the screen 1210 for live broadcasting). The function may include a remote play function of the game application executed in the user terminal 1142, by using another user terminal different from the user terminal 1142.

Referring to FIG. 12B, the user terminals 1141 and 1142 interconnected for a remote play function are illustrated. The user terminals 1141 and 1142 may be connected via a short-range wireless communication protocol such as Wi-Fi Direct and/or Bluetooth. An embodiment is not limited thereto, and the user terminals 1141 and 1142 may be connected to each other via a cellular protocol such as long-term evolution (LTE), 5G new radio (NR), 6G, and/or above-6G. It is assumed that a game launcher is installed in all of the user terminals 1141 and 1142, and authentication of the user U1 in each of the user terminals 1141 and 1142 based on the game launcher is completed.

When executing a game application in the user terminal 1141 having a relatively limited resource, such as a smartphone, quality of a user experience associated with a game may be reduced. The quality may be evaluated by an indicator such as frames-per-second (fps), response delay, and/or resolution. Quality of a user experience in a case of executing the game application in the user terminal 1142, which is a desktop, may be better than quality of a user experience in a case of executing the game application in the user terminal 1141. Referring to FIG. 12B, the user terminal 1142 may transmit, to the user terminal 1141, a screen 1220 generated (or rendered) by processing circuitry (e.g., a graphic processing unit (GPU)) of the user terminal 1142. The operation of transmitting the screen 1220 may include an operation (e.g., streaming) of transmitting, via a communication link L6, a bitstream representing the screen 1220.

In an exemplary state of FIG. 12B in which the user terminal 1142 displays the screen 1220 to the user terminal 1141, the user terminal 1141 may display the screen 1220 on a display based on execution of the game launcher. For example, without installation and/or execution of a game application for communicating with the server 1120, the user terminal 1141 may display, on the display, the screen 1220 associated with a game service provided by the server 1120. The user terminal 1141 may display the screen 1220 provided by the user terminal 1142 based on execution of the game launcher.

Referring to FIG. 12B, in an embodiment in which the user terminal 1142 generates the screen 1220 to be displayed by the user terminal 1141, the user terminal 1142 may display the screen 1220 including a UI associated with the user terminal 1141, which is a smartphone. The UI may include a virtual joystick including a visual object 1222 having a circular form that is draggable (or movable) by a touch input on a region 1221 having a circular form. The UI may include a group 1223 of touchable visual objects capable of adjusting a state of the PC 1215. Comparing FIGS. 12A and 12B, the screen 1210 of FIG. 12A displayed via a display of the user terminal 1142, which is a desktop, may not include the visual object 1222 and/or the group 1223. In a state of transmitting the screen 1220 to the user terminal 1141, which is a smartphone, the user terminal 1141 receiving the screen 1220 may superimpose, on the screen 1220, the group 1223 and the region 1221 including the visual object 1222. For example, a screen 1225 displayed on the display of the user terminal 1141 may further include the visual object 1222, the region 1221, and the group 1223 for guiding a touch input.

Referring to FIG. 12B, while displaying the screen 1225 based on the screen 1220 provided by the user terminal 1142, the user terminal 1141 may receive an input of the user U1 associated with the screen 1225. In response to the input, the user terminal 1141 may transmit, to the user terminal 1142, a signal indicating the input. The user terminal 1142 receiving the signal may communicate with the server 1120, and may at least partially change a state of the virtual space 1130 and/or the PC 1215 by using the input corresponding to the signal. The user U1 may view, via the user terminal 1141, the screen 1220 representing the at least partially changed state of the virtual space 1130 and/or the PC 1215.

As described above, an embodiment in which the server 1120 for providing the game service of FIG. 12B and the user terminal 1142 directly communicate, and the user terminal 1141 indirectly communicates with the server 1120 by using the user terminal 1142 has been described, but an embodiment is not limited thereto. For example, the user terminal 1141 receiving the input of the user U1 associated with the screen 1225 may transmit, to the server 1120 via a communication link L7, a signal including information associated with the input. The signal may be directly transmitted to the server 1120 independently of the communication links L4 and L6 established by the user terminal 1142. For example, in order to reduce delay regarding an input of the user U1 or improve responsiveness of the game service provided by the server 1120, the user terminal 1141 may transmit the signal via the communication link L7. The server 1120 receiving the signal may transmit, to the user terminal 1142 via the communication link L4, a signal (or information) indicating a state of the virtual space 1130 changed based on the signal. The user terminal 1142 receiving the signal may perform rendering regarding the screen 1220 to be provided to the user terminal 1141 via the communication link L6. After a signal associated with the rendered screen 1220 is transmitted to the user terminal 1141 via the communication link L6, the user terminal 1141 may display a screen 1225 based on the signal (e.g., a screen in which the visual object 1222, the region 1221, and the group 1223 are superimposed on the screen 1220).

For example, when the communication link L6 between the user terminals 1141 and 1142 is blocked, the user terminal 1141 may establish at least one of the direct communication link L7 between the server 1120 for providing the game service and the user terminal 1141 and/or a direct communication link L8 between the server 1110 for providing the game platform service and the user terminal 1141.

Although an operation in which a signal representing the screen 1220 is transmitted between the user terminals 1141 and 1142 commonly logged in by the user U1 has been described, an embodiment is not limited thereto. For example, the user terminal 1142 may transmit, via the server 1110, the signal representing the screen 1220 to user terminals of other users logged into the server 1110. A function in which the user terminal 1142 transmits the signal to the user terminals of the other users logged into the server 1110 may be referred to as a broadcasting function.

Referring to FIG. 12C, a server 1230 for a cloud game may be connected with the user terminal 1142. For example, when a request for providing a game service based on a cloud is identified in the user terminal 1142, the server 1110 may request, to the server 1230, provision of a cloud service based on the server 1230. The request may be transmitted to the server 1230 via a communication link L9 between the server 1110 and the server 1230. In response to the request, the server 1230 may establish a communication link L10 between the server 1120 for a game service and the server 1230 and a communication link L11 between the server 1120 and the user terminal 1142. The request transmitted via the communication link L9 may include information associated with the user terminal 1142 transmitting the request and/or the game service.

In an embodiment, the server 1230 may perform rendering of the screen 1210 to be displayed on the user terminal 1142. The server 1230 may transmit, to the user terminal 1142 via the communication link L11 between the user terminal 1142 and the server 1230, a signal (or a bitstream) associated with the screen 1210 rendered by the server 1230. The user terminal 1142 receiving the signal may display, on the display, the screen 1210 indicated by the signal.

In an exemplary state of FIG. 12C, the user terminal 1142 displaying the screen 1210 may receive a user input associated with the screen 1210. In response to a user input received from the user U1, the user terminal 1142 may transmit, to the server 1230 via the communication link L11, a signal indicating the user input. The server 1230 receiving the signal may execute a function associated with the user input. For example, the server 1230 executing the function may include an operation of at least partially changing a state of the virtual space 1130 provided by the server 1110 by communicating with the server 1110 via the communication link L10. For example, the server 1230 executing the function may include an operation of re-rendering the screen 1210 to be transmitted to the user terminal 1142 based on the at least partially changed state of the virtual space 1130. For example, the server 1230 executing the function may further transmit, via the communication link L11, a signal associated with the re-rendered screen 1210.

As described above, by using the game launcher, the user terminal 1141 may display the screen 1220 of the game application executed in another user terminal (in an embodiment of FIG. 12B, the user terminal 1142), and may respond to an interaction of the user U1 associated with the screen 1220. The user terminal 1141 may indirectly perform graphic rendering (e.g., visualization of a three-dimensional graphic object) by using a resource of the user terminal 1142. Even when the user terminal 1141 does not have a capacity (e.g., an available capacity of a flash storage) required for installing the game application, or the user terminal 1141 does not have a resource (e.g., a specification of a GPU and/or a CPU) required for executing the game application, the user terminal 1141 executing the game launcher may provide a user experience associated with the game application.

Hereinafter, with reference to FIGS. 13A to 13D, exemplary functions supported by a user terminal executing a game launcher will be described.

FIGS. 13A, 13B, 13C, and 13D illustrate exemplary functions supported by a game launcher executed by a user terminal (e.g., the user terminals 1141, 1142, 1143, 1151, and 1152 of FIG. 11). Referring to FIGS. 13A to 13D, example states 1301, 1302, 1303, and 1304 of a screen displayed by the user terminal executing the game launcher are illustrated. After completing authentication for a user of the user terminal by using the game launcher, the user terminal may display an exemplary screen illustrated in FIGS. 13A to 13D. Referring to FIG. 13A, the user terminal displaying the screen provided by the game launcher may display visual objects 1311, 1312, 1313, and 1314 respectively corresponding to options for adjusting a mode of the screen. For example, the visual object 1311 may correspond to a function for outputting a list of a plurality of game applications executable by the user terminal. For example, the visual object 1312 may correspond to a function for outputting a list of one or more game applications installed in the user terminal. For example, the visual object 1313 may correspond to a function for executing a messenger service based on a game platform service. For example, the visual object 1314 may correspond to a function for executing a community service regarding users subscribed to the game platform service.

In the state 1301 in which a first option corresponding to the visual object 1311 is selected, the user terminal may provide a screen capable of downloading game applications executable using the game launcher. In the state 1302 in which a second option corresponding to the visual object 1312 is selected, the user terminal may provide a screen associated with one or more game applications installed in the user terminal. In the state 1303 in which a third option corresponding to the visual object 1313 is selected, the user terminal may provide a screen for exchange of messages (e.g., transmission and/or reception of messages) between users logged into the game platform service. In the state 1304 in which a fourth option corresponding to the visual object 1314 is selected, the user terminal may provide a screen for exchange of information (e.g., posts) between users subscribed to the game platform service.

In a region 1315 of the screen of FIG. 13A, the user terminal may display a list of game applications. The list may be provided from a server (e.g., the server 1110 of FIGS. 11, 12A, and/or 12B) providing the game platform service. One or more icons (e.g., an icon 1319) displayed in the region 1315 may correspond to a specific game application included in the list. For example, in response to an input for selecting the icon 1319, the user terminal may display, in the screen, a UI for downloading a game application corresponding to the icon 1319.

In the state 1301 of displaying the list of the game applications via the region 1315, the user terminal may display visual objects 1316, 1317, and 1318 for filtering the game applications included in the list. The visual object 1316 may correspond to an option for displaying all game applications included in the list in the region 1315. The visual object 1317 may correspond to an option for displaying, in the region 1315, a sub-list of one or more game applications executable in a personal computer from among the game applications included in the list. The visual object 1318 may correspond to an option for displaying, in the region 1315, a sub-list of one or more game applications executable in a smartphone from among one or more game applications included in the list.

FIG. 13A is a diagram representing, for example, a screen in which the first option is executed in the game launcher of the user terminal by selecting the first visual object 1311 capable of outputting the list of the game applications executable in the user terminal.

Referring to the exemplary screen of FIG. 13A, the user terminal may display a visual object 1320 mapped to a function for streaming a screen of a game application executed by using the game launcher. For example, in response to an input for selecting the visual object 1320, the user terminal may display a list of other user terminals in which a user (e.g., the users U1 and U2 of FIG. 11) of the user terminal is logged in. For example, when the input is received while streaming the screen of the game application, the user terminal may display a pop-up window indicating that the screen of the game application is being streamed. For example, when the input is received while preparing streaming of the screen of the game application, the user terminal may display a pop-up window indicating that streaming of the screen of the game application is scheduled to start. The pop-up window of the example may include a button and/or a hyperlink for receiving an input for stopping or restarting streaming of the screen of the game application. The user terminal receiving an input for selecting another user terminal in the list may execute a function of transmitting, to the another user terminal selected by the input, a signal associated with the screen. FIG. 13B is a diagram representing, for example, a screen in which the second option is executed in the game launcher of the user terminal by selecting the visual object 1312 capable of providing a screen associated with the game application installed in the user terminal.

Referring to FIG. 13B, in the state 1302 in which the second option corresponding to the visual object 1312 is selected, the user terminal may display the list of the game applications installed in the user terminal. The user terminal may display a region 1324 and visual objects 1321, 1322, and 1323 for switching a UI displayed in the region 1324. In the state 1302 in which the visual object 1321 is selected, the user terminal may display, in the region 1324, visual objects respectively representing the game applications (e.g., visual objects respectively corresponding to an A game application and a B game application) installed in the user terminal. In the state 1302 in which the visual object 1321 is selected, the user terminal may further display, in the region 1324, together with the visual objects respectively corresponding to the game applications installed in the user terminal, a visual object 1329 for switching to the state 1301 for downloading a game application.

The visual objects 1322 and 1323 different from the visual object 1321 may respectively correspond to the game applications installed in the user terminal. For example, the visual object 1322 may correspond to the A game application installed in the user terminal, and the visual object 1323 may correspond to the B game application installed in the user terminal. For example, in response to an input for selecting the visual object 1322, the user terminal may display, in the region 1324, a UI associated with the A game application. The UI may include a visual object for executing the A game application.

In response to an input for selecting the visual object 1313, the user terminal may display the screen displayed in the state 1303 of FIG. 13C. The screen may be displayed as superimposed on a screen executed for the game launcher (e.g., a pop-up window).

FIG. 13C is a diagram representing, for example, a screen in which the third option is executed in the game launcher of the user terminal by selecting the third visual object 1313 capable of providing a screen for exchange of messages between users of the game platform service.

Referring to FIG. 13C, in the screen, the user terminal may display a list 1331 of game applications to which a user logged into the user terminal subscribes. The list 1331 may include chatting channels respectively corresponding to the game applications and/or chatting channels provided via a game service. For example, the chatting channels provided via the game service may include a chatting channel dedicated to a guild (or a party) provided via the game service and a one-to-one chatting channel (e.g., a whisper channel) indicated by a user account of the user terminal. In a region 1332 of the exemplary screen of FIG. 13C, the user terminal may display one or more messages transmitted or received via any one chatting channel among the chatting channels. The user terminal may display visual objects 1333, 1334, and 1335 for transmitting text, an emoticon, and/or an image (or a video) to the chatting channel corresponding to the region 1332. The user terminal may display a visual object 1336 for uploading, to the chatting channel, text input to the visual object 1333, which is a text box. Via the screen of FIG. 13C, the user terminal may display a visual object 1337 mapped to a function for adding a new chatting channel.

FIG. 13D is a diagram representing, for example, a screen in which the fourth option is executed in the game launcher of the user terminal by selecting the visual object 1314 capable of writing posts between users of the game platform service.

Referring to FIG. 13D, in the state 1304 in which the fourth option corresponding to the visual object 1314 is selected, the user terminal may provide a list of posts registered in the game platform service. The user terminal may provide the list via a region 1342 in the screen. For example, an element 1345 in the region 1342 may correspond to a specific post included in the list. In response to an input for selecting the element 1345, the user terminal may display, in the screen, the post corresponding to the element 1345. The user terminal may display, in a region 1341, visual objects for filtering the posts displayed in the region 1342. The visual objects displayed in the region 1341 may respectively correspond to hash tags (or index words) assigned to posts. For example, a visual object 1344 may be displayed to provide, via the region 1342, a list of posts including an exemplary hash tag (e.g., a hash tag including a character string of "13UPDATE"). For example, a visual object 1343 may be displayed to provide a list of all posts in the region 1342 by deselecting hash tags displayed via the region 1341.

As described above, an electronic device (e.g., the electronic device 200) may comprise memory (e.g., the memory 206) storing instructions. The electronic device may comprise communication circuitry (e.g., the communication circuitry 205). The electronic device may comprise at least one processor (e.g., the at least one processor 207). The instructions, when executed by the at least one processor individually or collectively, may cause the electronic device to receive, via the communication circuitry from a first external electronic device, a first video indicating an execution screen of a game application being executed via the first external electronic device. The instructions, when executed by the at least one processor individually or collectively, may cause the electronic device to, while receiving the first video, transmit, via the communication circuitry to a second external electronic device, the first video. The instructions, when executed by the at least one processor individually or collectively, may cause the electronic device to, while transmitting the first video, receive, via the communication circuitry from the second external electronic device, a first signal indicating a selection regarding a visual object represented by the first video and an input regarding the selection. The instructions, when executed by the at least one processor individually or collectively, may cause the electronic device to, based on receiving the first signal, transmit, via the communication circuitry to the first external electronic device, a second signal causing the first external electronic device to display a visual indication indicating the selection as superimposed on the visual object and to display information associated with the input.

According to an embodiment, the information may include a link indicating a media content, associated with the visual object, determined via a trained model for recommending a media content regarding the game application. The link may be displayed based on a first user input received regarding the visual indication.

According to an embodiment, the information may include text, indicated by the input, obtained from the second external electronic device.

According to an embodiment, the instructions, when executed by the at least one processor individually or collectively, may cause the electronic device to, based on receiving the first signal, transmit, via the communication circuitry to the first external electronic device, a third signal causing the first external electronic device to display, at an outside of an execution screen of the game application, a visual representation for notifying the selection. The third signal may further cause the first external electronic device to display a first user interface (UI) object including an image frame included in the first video and text indicated by the input in accordance with a second user input received via the first external electronic device regarding the visual representation.

According to an embodiment, the instructions, when executed by the at least one processor individually or collectively, may cause the electronic device to, based on receiving the first signal, identify a region on the first video in which the visual object determined in accordance with the selection is represented. The instructions, when executed by the at least one processor individually or collectively, may cause the electronic device to, based on combining the visual indication on the region, generate a second video on which the visual indication is displayed as superimposed on the visual object.

According to an embodiment, the instructions, when executed by the at least one processor individually or collectively, may cause the electronic device to, based on receiving the first signal, transmit, via the communication circuitry to a third external electronic device different from the second external electronic device, a fourth signal causing the third external electronic device to provide a second video of the game application on which the visual indication is displayed as superimposed on the visual object, and text indicated by the input.

According to an embodiment, the fourth signal may further cause the third external electronic device to display the second video on a streaming region for displaying a streamed video, and to display the text on a chatting region arranged associated with the streaming region.

According to an embodiment, the instructions, when executed by the at least one processor individually or collectively, may cause the electronic device to, before receiving the first signal, based on transmitting the first video, receive, via the communication circuitry from the second external electronic device, a fifth signal indicating a region of interest (ROI) on the first video. The ROI may be determined in accordance with a third user input received via the second external electronic device. The instructions, when executed by the at least one processor individually or collectively, may cause the electronic device to, in accordance with performing an object recognition regarding the ROI, determine one or more candidate visual objects associated with the game application. The instructions, when executed by the at least one processor individually or collectively, may cause the electronic device to transmit, via the communication circuitry to the second external electronic device, a sixth signal causing the second external electronic device to display a second UI object including the one or more candidate visual objects. The instructions, when executed by the at least one processor individually or collectively, may cause the electronic device to receive, via the communication circuitry from the second external electronic device, the first signal indicating the input and the selection regarding the visual object. The visual object may be included in the one or more candidate visual objects.

According to an embodiment, the instructions, when executed by the at least one processor individually or collectively, may cause the electronic device to, while receiving the first video, respectively transmit, via the communication circuitry to the second external electronic device and a third external electronic device, the first video. The instructions, when executed by the at least one processor individually or collectively, may cause the electronic device to receive, via the communication circuitry from the first external electronic device, a seventh signal indicating a user input received by the first external electronic device. The instructions, when executed by the at least one processor individually or collectively, may cause the electronic device to, based on a determination that the user input is a fourth user input, transmit, via the communication circuitry to the second external electronic device among the second external electronic device and the third external electronic device, a fourth signal for providing a second video of the game application on which the visual indication is displayed as superimposed on the visual object and text indicated by the input. The instructions, when executed by the at least one processor individually or collectively, may cause the electronic device to, based on a determination that the user input is a fifth user input, respectively transmit, via the communication circuitry to the second external electronic device and the third external electronic device, the fourth signal for providing the second video and the text.

As described above, a method executed in an electronic device (e.g., the electronic device 200) with communication circuitry (e.g., the communication circuitry 205) may comprise receiving, via the communication circuitry from a first external electronic device, a first video indicating an execution screen of a game application being executed via the first external electronic device. The method may comprise, while receiving the first video, transmitting, via the communication circuitry to a second external electronic device, the first video. The method may comprise, while transmitting the first video, receiving, via the communication circuitry from the second external electronic device, a first signal indicating a selection regarding a visual object represented by the first video and an input regarding the selection. The method may comprise, based on receiving the first signal, transmitting, via the communication circuitry to the first external electronic device, a second signal causing the first external electronic device to display a visual indication indicating the selection as superimposed on the visual object and to display information associated with the input.

According to an embodiment, the information may include a link indicating a media content, associated with the visual object, determined via a trained model for recommending a media content regarding the game application. The link may be displayed based on a first user input received regarding the visual indication.

According to an embodiment, the information may include text, indicated by the input, obtained from the second external electronic device.

According to an embodiment, the method may comprise, based on receiving the first signal, transmitting, via the communication circuitry to the first external electronic device, a third signal causing the first external electronic device to display, at an outside of an execution screen of the game application, a visual representation for notifying the selection. The third signal may further cause the first external electronic device to display a first user interface (UI) object including an image frame included in the first video and text indicated by the input in accordance with a second user input received via the first external electronic device regarding the visual representation.

According to an embodiment, the method may comprise, based on receiving the first signal, identifying a region on the first video in which the visual object determined in accordance with the selection is represented. The method may comprise, based on combining the visual indication on the region, generating a second video on which the visual indication is displayed as superimposed on the visual object.

According to an embodiment, the method may comprise, based on receiving the first signal, transmitting, via the communication circuitry to the second external electronic device, a fourth signal causing the second external electronic device to provide a second video of the game application on which the visual indication is displayed as superimposed on the visual object, and text indicated by the input.

According to an embodiment, the method may comprise, based on receiving the first signal, transmitting, via the communication circuitry to a third external electronic device different from the second external electronic device, a fourth signal causing the third external electronic device to provide a second video of the game application on which the visual indication is displayed as superimposed on the visual object, and text indicated by the input.

According to an embodiment, the fourth signal may further cause the third external electronic device to display the second video on a streaming region for displaying a streamed video, and to display the text on a chatting region arranged associated with the streaming region.

According to an embodiment, the method may comprise, before receiving the first signal, based on transmitting the first video, receiving, via the communication circuitry from the second external electronic device, a fifth signal indicating a region of interest (ROI) on the first video. The ROI may be determined in accordance with a third user input received via the second external electronic device. The method may comprise, in accordance with performing an object recognition regarding the ROI, determining one or more candidate visual objects associated with the game application. The method may comprise transmitting, via the communication circuitry to the second external electronic device, a sixth signal causing the second external electronic device to display a second UI object including the one or more candidate visual objects. The method may comprise receiving, via the communication circuitry from the second external electronic device, the first signal indicating the input and the selection regarding the visual object. The visual object may be included in the one or more candidate visual objects.

According to an embodiment, the method may comprise, while receiving the first video, respectively transmitting, via the communication circuitry to the second external electronic device and a third external electronic device, the first video. The method may comprise receiving, via the communication circuitry from the first external electronic device, a seventh signal indicating a user input received by the first external electronic device. The method may comprise, based on a determination that the user input is a fourth user input, transmitting, via the communication circuitry to the second external electronic device among the second external electronic device and the third external electronic device, a fourth signal for providing a second video of the game application on which the visual indication is displayed as superimposed on the visual object and text indicated by the input. The method may comprise, based on a determination that the user input is a fifth user input, respectively transmitting, via the communication circuitry to the second external electronic device and the third external electronic device, the fourth signal for providing the second video and the text.

As described above, in a non-transitory computer readable storage medium storing one or more programs, the one or more programs may comprise instructions to, when executed by an electronic device (e.g., the electronic device 200) with communication circuitry, cause the electronic device to receive, via the communication circuitry (e.g., the communication circuitry 205) from a first external electronic device, a first video indicating an execution screen of a game application being executed via the first external electronic device. The one or more programs may comprise instructions to, when executed by the electronic device, cause the electronic device to, while receiving the first video, transmit, via the communication circuitry to a second external electronic device, the first video. The one or more programs may comprise instructions to, when executed by the electronic device, cause the electronic device to, while transmitting the first video, receive, via the communication circuitry from the second external electronic device, a first signal indicating a selection regarding a visual object represented by the first video and an input regarding the selection. The one or more programs may comprise instructions to, when executed by the electronic device, cause the electronic device to, based on receiving the first signal, transmit, via the communication circuitry to the first external electronic device, a second signal causing the first external electronic device to display a visual indication indicating the selection as superimposed on the visual object and to display information associated with the input.

According to an embodiment, the information may include a link indicating a media content, associated with the visual object, determined via a trained model for recommending a media content regarding the game application. The link may be displayed based on a first user input received regarding the visual indication.

According to an embodiment, the information may include text, indicated by the input, obtained from the second external electronic device.

According to an embodiment, the one or more programs may comprise instructions to, when executed by the electronic device, cause the electronic device to, based on receiving the first signal, transmit, via the communication circuitry to the first external electronic device, a third signal causing the first external electronic device to display, at an outside of an execution screen of the game application, a visual representation for notifying the selection. The third signal may further cause the first external electronic device to display a first user interface (UI) object including an image frame included in the first video and text indicated by the input in accordance with a second user input received via the first external electronic device regarding the visual representation.

According to an embodiment, the one or more programs may comprise instructions to, when executed by the electronic device, cause the electronic device to, based on receiving the first signal, identify a region on the first video in which the visual object determined in accordance with the selection is represented. The one or more programs may comprise instructions to, when executed by the electronic device, cause the electronic device to, based on combining the visual indication on the region, generate a second video on which the visual indication is displayed as superimposed on the visual object.

According to an embodiment, the one or more programs may comprise instructions to, when executed by the electronic device, cause the electronic device to, based on receiving the first signal, transmit, via the communication circuitry to the second external electronic device, a fourth signal causing the second external electronic device to provide a second video of the game application on which the visual indication is displayed as superimposed on the visual object, and text indicated by the input.

According to an embodiment, The one or more programs may comprise instructions to, when executed by the electronic device, cause the electronic device to, based on receiving the first signal, transmit, via the communication circuitry to a third external electronic device different from the second external electronic device, a fourth signal causing the third external electronic device to provide a second video of the game application on which the visual indication is displayed as superimposed on the visual object, and text indicated by the input.

According to an embodiment, the fourth signal may further cause the third external electronic device to display the second video on a streaming region for displaying a streamed video, and to display the text on a chatting region arranged associated with the streaming region.

According to an embodiment, the one or more programs may comprise instructions to, when executed by the electronic device, cause the electronic device to, before receiving the first signal, based on transmitting the first video, receive, via the communication circuitry from the second external electronic device, a fifth signal indicating a region of interest (ROI) on the first video. The ROI may be determined in accordance with a third user input received via the second external electronic device. The one or more programs may comprise instructions to, when executed by the electronic device, cause the electronic device to, in accordance with performing an object recognition regarding the ROI, determine one or more candidate visual objects associated with the game application. The one or more programs may comprise instructions to, when executed by the electronic device, cause the electronic device to transmit, via the communication circuitry to the second external electronic device, a sixth signal causing the second external electronic device to display a second UI object including the one or more candidate visual objects. The one or more programs may comprise instructions to, when executed by the electronic device, cause the electronic device to receive, via the communication circuitry from the second external electronic device, the first signal indicating the input and the selection regarding the visual object. The visual object may be included in the one or more candidate visual objects.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
communication circuitry;
memory comprising one or more storage media storing instructions; and
at least one processor comprising processing circuitry,
wherein the instructions, when executed by the at least one processor individually or collectively, cause the electronic device to:
receive, via the communication circuitry from a first external electronic device, a first video indicating an execution screen of a game application being executed via the first external electronic device,
while receiving the first video, transmit, via the communication circuitry to a second external electronic device, the first video,
while transmitting the first video, receive, via the communication circuitry from the second external electronic device, a first signal indicating a selection regarding a visual object represented by the first video and an input regarding the selection, and
based on receiving the first signal, transmit, via the communication circuitry to the first external electronic device, a second signal causing the first external electronic device to display a visual indication indicating the selection as superimposed on the visual object and to display information associated with the input.

2. The electronic device of claim 1, wherein the information includes a link indicating a media content, associated with the visual object, determined via a trained model for recommending a media content regarding the game application, and
wherein the link is displayed based on a first user input received regarding the visual indication.

3. The electronic device of claim 1, wherein the information includes text, indicated by the input, obtained from the second external electronic device.

4. The electronic device of claim 1, wherein the instructions, when executed by the at least one processor individually or collectively, cause the electronic device to:
based on receiving the first signal, transmit, via the communication circuitry to the first external electronic device, a third signal causing the first external electronic device to display, at an outside of an execution screen of the game application, a visual representation for notifying the selection, and
wherein the third signal further causes the first external electronic device to display a first user interface (UI) object including an image frame included in the first video and text indicated by the input in accordance with a second user input received via the first external electronic device regarding the visual representation.

5. The electronic device of claim 1, wherein the instructions, when executed by the at least one processor individually or collectively, cause the electronic device to:
based on receiving the first signal, identify a region on the first video in which the visual object determined in accordance with the selection is represented, and
based on combining the visual indication on the region, generate a second video on which the visual indication is displayed as superimposed on the visual object.

6. The electronic device of claim 1, wherein the instructions, when executed by the at least one processor individually or collectively, cause the electronic device to:
based on receiving the first signal, transmit, via the communication circuitry to the second external electronic device, a fourth signal causing the second external electronic device to provide a second video of the game application on which the visual indication is displayed as superimposed on the visual object, and text indicated by the input.

7. The electronic device of claim 1, wherein the instructions, when executed by the at least one processor individually or collectively, cause the electronic device to:
based on receiving the first signal, transmit, via the communication circuitry to a third external electronic device different from the second external electronic device, a fourth signal causing the third external electronic device to provide a second video of the game application on which the visual indication is displayed as superimposed on the visual object, and text indicated by the input.

8. The electronic device of claim 7, wherein the fourth signal further causes the third external electronic device to display the second video on a streaming region for displaying a streamed video, and to display the text on a chatting region arranged associated with the streaming region.

9. The electronic device of claim 1, wherein the instructions, when executed by the at least one processor individually or collectively, cause the electronic device to:
before receiving the first signal, based on transmitting the first video, receive, via the communication circuitry from the second external electronic device, a fifth signal indicating a region of interest (ROI) on the first video, wherein the ROI is determined in accordance with a third user input received via the second external electronic device;
in accordance with performing an object recognition regarding the ROI, determine one or more candidate visual objects associated with the game application;
transmit, via the communication circuitry to the second external electronic device, a sixth signal causing the second external electronic device to display a second UI object including the one or more candidate visual objects; and
receive, via the communication circuitry from the second external electronic device, the first signal indicating the input and the selection regarding the visual object, and
wherein the visual object is included in the one or more candidate visual objects.

10. The electronic device of claim 1, wherein the instructions, when executed by the at least one processor individually or collectively, cause the electronic device to:
while receiving the first video, respectively transmit, via the communication circuitry to the second external electronic device and a third external electronic device, the first video,
receive, via the communication circuitry from the first external electronic device, a seventh signal indicating a user input received by the first external electronic device,
based on a determination that the user input is a fourth user input, transmit, via the communication circuitry to the second external electronic device among the second external electronic device and the third external electronic device, a fourth signal for providing a second video of the game application on which the visual indication is displayed as superimposed on the visual object and text indicated by the input, and
based on a determination that the user input is a fifth user input, respectively transmit, via the communication circuitry to the second external electronic device and the third external electronic device, the fourth signal for providing the second video and the text.

11. A non-transitory computer readable storage medium storing one or more programs, the one or more programs comprising instructions to, when executed by an electronic device with communication circuitry, cause the electronic device to:
receive, via the communication circuitry from a first external electronic device, a first video indicating an execution screen of a game application being executed via the first external electronic device,
while receiving the first video, transmit, via the communication circuitry to a second external electronic device, the first video,
while transmitting the first video, receive, via the communication circuitry from the second external electronic device, a first signal indicating a selection regarding a visual object represented by the first video and an input regarding the selection, and
based on receiving the first signal, transmit, via the communication circuitry to the first external electronic device, a second signal causing the first external electronic device to display a visual indication indicating the selection as superimposed on the visual object and to display information associated with the input.

12. The non-transitory computer readable storage medium of claim 11, wherein the information includes a link indicating a media content, associated with the visual object, determined via a trained model for recommending a media content regarding the game application, and
wherein the link is displayed based on a first user input received regarding the visual indication.

13. The non-transitory computer readable storage medium of claim 11, wherein the information includes text, indicated by the input, obtained from the second external electronic device.

14. The non-transitory computer readable storage medium of claim 11, wherein the one or more programs comprise instructions to, when executed by the electronic device, cause the electronic device to:
based on receiving the first signal, transmit, via the communication circuitry to the first external electronic device, a third signal causing the first external electronic device to display, at an outside of an execution screen of the game application, a visual representation for notifying the selection, and
wherein the third signal further causes the first external electronic device to display a first user interface (UI) object including an image frame included in the first video and text indicated by the input in accordance with a second user input received via the first external electronic device regarding the visual representation.

15. The non-transitory computer readable storage medium of claim 11, wherein the one or more programs comprise instructions to, when executed by the electronic device, cause the electronic device to:
based on receiving the first signal, identify a region on the first video in which the visual object determined in accordance with the selection is represented, and
based on combining the visual indication on the region, generate a second video on which the visual indication is displayed as superimposed on the visual object.

16. The non-transitory computer readable storage medium of claim 11, wherein the one or more programs comprise instructions to, when executed by the electronic device, cause the electronic device to:
based on receiving the first signal, transmit, via the communication circuitry to the second external electronic device, a fourth signal causing the second external electronic device to provide a second video of the game application on which the visual indication is displayed as superimposed on the visual object, and text indicated by the input.

17. The non-transitory computer readable storage medium of claim 11, wherein the one or more programs comprise instructions to, when executed by the electronic device, cause the electronic device to:
based on receiving the first signal, transmit, via the communication circuitry to a third external electronic device different from the second external electronic device, a fourth signal causing the third external electronic device to provide a second video of the game application on which the visual indication is displayed as superimposed on the visual object, and text indicated by the input.

18. The non-transitory computer readable storage medium of claim 17, wherein the fourth signal further causes the third external electronic device to display the second video on a streaming region for displaying a streamed video, and to display the text on a chatting region arranged associated with the streaming region.

19. The non-transitory computer readable storage medium of claim 11, wherein the one or more programs comprise instructions to, when executed by the electronic device, cause the electronic device to:
before receiving the first signal, based on transmitting the first video, receive, via the communication circuitry from the second external electronic device, a fifth signal indicating a region of interest (ROI) on the first video, wherein the ROI is determined in accordance with a third user input received via the second external electronic device;
in accordance with performing an object recognition regarding the ROI, determine one or more candidate visual objects associated with the game application;
transmit, via the communication circuitry to the second external electronic device, a sixth signal causing the second external electronic device to display a second UI object including the one or more candidate visual objects; and
receive, via the communication circuitry from the second external electronic device, the first signal indicating the input and the selection regarding the visual object, and
wherein the visual object is included in the one or more candidate visual objects.

20. A method executed in an electronic device with communication circuitry, the method comprising:
receiving, via the communication circuitry from a first external electronic device, a first video indicating an execution screen of a game application being executed via the first external electronic device,
while receiving the first video, transmitting, via the communication circuitry to a second external electronic device, the first video,
while transmitting the first video, receiving, via the communication circuitry from the second external electronic device, a first signal indicating a selection regarding a visual object represented by the first video and an input regarding the selection, and
based on receiving the first signal, transmitting, via the communication circuitry to the first external electronic device, a second signal causing the first external electronic device to display a visual indication indicating the selection as superimposed on the visual object and to display information associated with the input.
